(19) United States
(12) Patent Application Publication
(10) Pub. No.: US 2024/0267113 A1
(43) Pub. Date: Aug. 8, 2024

(54) METHOD FOR OPERATING A SECONDARY STATION

(71) Applicant: KONINKLIJKE PHILIPS N.V., EINDHOVEN (NL)

(72) Inventors: Walter Dees, Eindhoven (NL); Esko Dijk, Eindhoven (NL); Jesus Gonzalez Tejeria, Eindhoven (NL); Vignesh Raja Karuppiah Ramachandran, Eindhoven (NL); Johannes Arnoldus Cornelis Bernsen, Eindhoven (NL)

(21) Appl. No.: 18/567,237

(22) PCT Filed: Jun. 8, 2022
(86) PCT No.: PCT/EP2022/065447

§ 371 Date: Dec. 5, 2023

(30) Foreign Application Priority Data
Jun. 8, 2021 (EP) 21178347.7

(51) Int. Cl. H04B 7/155; H04W 72/232; H04W 84/04; H04W 88/04

(52) U.S. Cl. CPC H04B 7/15542; H04W 72/232; H04W 84/047; H04W 88/04

(57) ABSTRACT

Method for operating a wireless terminal to communicate in a cellular network, said cellular network comprising at least one first cell station, said first cell station serving a first cell, and at least one relay station served by a second cell station serving a second cell, the method comprising the steps of the wireless terminal receiving a downlink signal sent by the first cell station and carrying downlink control information, said downlink control information including at least an indication of an allocated uplink resource to be used by the wireless terminal for transmitting a signal to the relay station, the wireless terminal generating uplink information, the wireless terminal transmitting to the relay station on the allocated uplink resource the signal carrying the uplink information, said uplink information to be forwarded to the second cell station.

### FIELD OF THE INVENTION

The present invention relates to the field of wireless communications, and in particular to relaying architectures in the context of cellular networks, like the UMTS Long Term Evolution (LTE) or LTE Advanced (both included in 4G), New Radio (NR) (5G) or other cellular networks or mobile communication networks.

### BACKGROUND OF THE INVENTION

In conventional cellular networks, a primary station serves a plurality of secondary stations located within a cell served by this primary station. Wireless communication from the primary station towards each secondary station is done on downlink channels. Conversely, wireless communication from each secondary towards the primary station is done on uplink channels. The wireless communication can include data traffic (sometimes referred to as User Data), and control information (also referred to sometimes as signalling). This control information typically comprises information to assist the primary station and/or the secondary station to exchange data traffic (e.g. resource allocation/requests, physical transmission parameters, information on the state of the respective stations). The data traffic typically includes the useful payload exchanged for the use of the end user applications. The data traffic is typically formed of IP (Internet Protocol) packets carried in the data plane.

In the context of cellular networks as standardized by 3GPP, the primary station is referred to as a base station, or a gNodeB (or gNB) in 5G (NR) or an eNodeB (or eNB) in 4G (LTE) or a cell station. The eNB/gNB is part of the Radio Access Network (RAN), which interfaces to functions in the Core Network (CN). In the same context, the secondary station corresponds to a mobile station, or a User Equipment (or a UE) in 4G/5G, which is a wireless client device or a specific role played by such device. The term “node” is also used to denote either a UE or a gNB/eNB. “NF” denotes a Network Function in the CN. The direct link between the primary station and the secondary stations is referred to as the Uu interface in 4G or 5G networks.

The secondary station can be included in wireless terminals of different types, e.g. mobile phones, vehicles (for V2V, vehicle-to-vehicle, or more general V2X, vehicle-to-everything communication), IoT devices, including low-power medical sensors for health monitoring, medical (emergency) diagnosis and treatment devices, for hospital use or first-responder use, Virtual Reality (VR) headsets, or wireless wearables in general. These wireless terminals differ vastly in their operation or characteristics, e.g. in terms of low-power operation, required bandwidth/data rate, tolerated maximum latency, achievable transmit output power, achievable duty cycle in transmission and/or reception, or required mobility. The bandwidth available to a device for Uplink (UL) data and Downlink (DL) data can be dynamically varied under control of a base station, based on data needs and on channel conditions at that point in time. A scheduler exists inside a base station to schedule the UL/DL transmissions of devices.

In the 3GPP, it has been introduced the role of a relay node as shown on FIG. 1A. This relay node 120 is a wireless communication station 120 that includes functionalities for relaying communication between a base station 100 (e.g. a gNB) and a UE 110. This relay function for example helps to extend the coverage of a cell 10 to an out-of-coverage (OoC) mobile station 110. This relay node 120 may be a mobile station or could be a different type of device. In the specifications for 4G, the Proximity Services (ProSe) functions are defined inter alia in TS23.303, and TS24.334 to enable—amongst others—connectivity for the cellular User Equipment (UE) 110 that is temporarily not in coverage of the cellular network base station (eNB) 100 serving the cell 10. This particular function is called ProSe UE-to-network relay, or Relay UE for short. The Relay UE 120 relays application and network traffic in two directions between the OoC UE 110 and the eNB 100. The local communication between the Relay UE 120 and the OoC UE 110 is called device-to-device (D2D) communication or Sidelink (also known as PC5) communication in TS23.303 and TS24.334. Once the relaying relation is established, the OoC-UE 110 is IP-connected via the Relay UE 120 and acts in a role of “Remote UE” 110. This situation means the Remote UE has an indirect network connection (as defined in TS22.261) to selected functions of the Core Network as opposed to a direct network connection to all Core Network functions that is the normal case.

However, while direct communication with a distant gNB requires a high energy consumption of a (wireless, typically battery-powered) wearable UE or IoT UE, the Sidelink operation also includes energy costly operations like sensing the control region to check whether messages are being addressed to the Remote UE. It leads to a high energy consumption of a (wireless, typically battery-powered) wearable UE or IoT UE when communicating as Remote UE via such a Relay UE due to sensing. It is to be noted that, in this application, the term “energy consumption” is used for what is sometimes indicated by the term “power consumption”. “Power consumption” is a physical misnomer, since power cannot be consumed. Power is the rate at which energy is “consumed” or rather is transformed from a first type of energy (e.g. electro-chemical energy available from the charge of a battery) into other types of energy. Likewise, “power-save mode” is in reality a mode where the power level of the device is set to a lower value than in normal operation, whereby energy, not power, is saved (or rather transformed less quickly) in this mode.

Further, besides the high energy consumption, the bandwidth available downstream to an indirectly connected (via a Relay UE) Remote UE is potentially limited, meaning that the Relay UE may sometimes have insufficient downstream data capacity. For example, one reason for this bottleneck may be that the resources allocated for Sidelink (SL) communication, needed by the Relay UE to send the data to the Remote UE, is a very limited subset of the total set of cellular resources available. It is also possible that the Relay UE needs to serve multiple Remote UEs at the same time so the scarce resources (spectrum, processing time, buffer memory, etc.) of the Relay UE need to be divided across multiple devices. Additionally, other Remote UEs may have higher priority to be served by the Relay UE. Another issue is the possible packet collision due to overlapping resource allocations (e.g. in mode 2 as defined in TS38.300 and/or TR 38.885 Rel. 16 and later) when the Remote UE is out of coverage and thus the resources for Remote UE to transmit on are not scheduled.

### SUMMARY OF THE INVENTION

One aim of the present invention is to alleviate the above-mentioned problems.

Another aim of the present invention is to propose a method for communicating in a network that allows a reduced energy consumption for Remote UEs.

Still another aim of the invention is to propose a method of a secondary station for communicating in a network which improves the latency while maintaining the energy consumption low.

Still another aim of the invention is to propose a secondary station that can flexibly operate in accordance with the optimal network topology to optimize the energy consumption.

Thus, in accordance with a first aspect of the invention, it is proposed a wireless terminal as claimed in claim 1 for communicating in a cellular network, said cellular network comprising at least one first cell station, said first cell station serving a first cell, and at least one relay station served by a second cell station serving a second cell,
the wireless terminal comprising
a controller to operate in a TX-limited operation mode,
a receiver configured by the controller in the TX-limited operation mode to receive first downlink signals sent directly by the first cell station and carrying respective first downlink control information, wherein at least one of the respective first downlink control information includes at least an indication of a first configuration parameter to be used by the wireless terminal for transmitting a signal directly to the relay station and at least one of said respective first downlink control information includes at least a second configuration parameter to be used by the wireless terminal for receiving a further downlink signal directly from the first cell station,
the controller being adapted to generate uplink information,
a transmitter configured by the controller in the TX-limited operation mode to transmit to the relay station using the first configuration parameter the second signal carrying the uplink information, said uplink information to be forwarded to the second cell station, and
wherein the receiver is further adapted to receive the further downlink signal directly from the first cell station using the second configuration parameter.

Throughout the embodiments of the invention and the various aspects of the invention and their variants, the configuration parameter may include one or more set of parameter values which are relative to the configuration of the communication. These may for example be resource (e.g. Resource Blocks (defined by e.g. time, and/or frequency, and/or codes, and/or spatial channel)), spatial beams). These may be other parameter values such as a selected transmission mode, a selected modulation scheme, a HARQ process. Further, these could be a combination of resources and other configuration values. While in the embodiments, many examples describe the indication of allocated resource, these embodiments could also apply on other configuration parameters.

In accordance with a first variant of the first aspect, the controller initiates TX-limited operation mode after the reception by the receiver of a TX limited operation mode activation signal, being a downlink signal sent directly by the first cell station indicating or triggering TX-limited operation mode activation.

In a second variant of the first aspect, which may be combined with the first variant, the controller initiates TX-limited operation mode operation if the transmit or receive operation meets one or more preconfigured signal strength/signal reception quality threshold or one or more signal transmission failure threshold, or if the energy levels of the wireless terminal are below a certain threshold, or upon discovery of the relay station.

In a third variant of the first aspect which may be combined with the first and/or the second variants, the transmitter is adapted to transmit an initial signal to the first cell station and/or to the relay station indicating or triggering TX-limited operation mode activation.

In a fourth variant of the first aspect which may be combined with one or more of the previous variant of the first aspect, the controller is adapted to operate alternatively in accordance with a first operation mode, being the TX-limited operation mode and a second operation mode,
the receiver being adapted in the second operation mode to receive second downlink signals sent directly by the first cell station and carrying respective second downlink control information, wherein at least one of the respective second downlink control information includes at least an indication of a third configuration parameter to be used by the wireless terminal for transmitting an uplink signal directly to the first cell station and at least one of the respective second downlink control information includes at least an indication of a fourth configuration parameter to be used by the wireless terminal for receiving a further downlink signal directly from the first cell station,
the controller being adapted to generate uplink information,
wherein the transmitter is configured by the controller in the second mode of operation to transmit to the first cell station using the third configuration parameter for direct communication to the first cell station, and the receiver is configured by the controller to receive the further downlink signal directly from the first cell station using the fourth configuration parameter.

In accordance with an alternative and more specific definition of the first aspect, it is proposed a wireless terminal for communicating in a cellular network, said cellular network further comprising at least one first cell station said first cell station serving a first cell, and at least one relay station served by a second cell station serving a second cell,
the wireless terminal comprising
a controller to operate the wireless terminal alternatively in accordance with a first operation mode (direct operation mode) and a second operation mode (Tx-limited operation mode),
a receiver adapted in the direct operation mode to receive first downlink signals sent directly by the first cell station and carrying respective first downlink control information, wherein at least one of the respective first downlink control information includes at least an indication of a first allocated uplink resource to be used by the wireless terminal for transmitting a first uplink signal directly to the first cell station and at least one of the respective first downlink control information includes at least an indication of a first allocated downlink resource to be used by the wireless terminal for receiving a further downlink signal directly from the first cell station, and in the TX-limited operation mode to receive second downlink signals sent directly by the first cell station and carrying respective second downlink control information, wherein at least one of said respective second downlink control information includes at least an indication of a second resource to be used by the wireless terminal for transmitting a second signal directly to the relay station and at least one of said respective second downlink control information includes at least a second allocated downlink resource to be used by the wireless terminal for receiving a further downlink signal directly from the first cell station,
the controller being adapted to generate uplink information,
a transmitter,
wherein in the direct operation mode, the transmitter is configured by the controller to transmit to the first cell station on the first allocated uplink resource for direct communication to the first cell station, and the receiver is configured by the controller to receive the further downlink signal directly from the first cell station on the first allocated downlink resource; and
wherein in the TX-limited operation mode, the transmitter is further configured by the controller to transmit to the relay station on the second resource the second signal carrying the uplink information, said uplink information to be forwarded to the second cell station, and the receiver is further configured by the controller to receive the further downlink signal directly from the first cell station on the second allocated downlink resource.

Thus, the wireless terminal of the first aspect and its variations may be able to adapt its operation, for example on a need basis or following some commands from the network. In the first mode of operation, the wireless terminal may communicate directly with the first cell station. In the second mode of operation, while the wireless terminal is still receiving messages from the first cell station, it does not transmit back to the first cell station but instead to a relay station. Thus, this allows a lower energy consumption and/or lower transmit power to be used when transmitting in case the relay station is closer to the wireless terminal than to the first cell station. Further, the resources to be used are however in this case still signaled by the first cell station on the downlink. This avoids the wireless terminal having to connect to the relay station and sense whether control data is being sent to it by the relay station, which could be energy consuming and slow depending on the available downlink bandwidth (i.e. Sidelink bandwidth for downstream data) of the relay station and depending on the method of resource allocation used for Sidelink transmissions. Downlink data is transmitted directly by the first cell station which thus enables a more reliable, lower-latency, higher data rate connection than an indirect connection through a relay station. The messages (or the information they contain) sent to the relay station can be forwarded to the network through the cell station serving the relay station.

The relay station may be served by the first cell station in the first cell, i.e. the same cell as the wireless terminal (which means that the second cell station is also the first cell station) or even in a different cell, thus served by a second cell station distinct from the first cell station.

In a variant of the first aspect of the invention, it is proposed that in the TX-limited operation mode, the transmitter is configured to refrain from transmitting on resources used for direct uplink communication to the first cell station.

This means that during the TX limited operation mode, the wireless terminal does not use resources allocated for transmission directly to the first cell station. Consequently, no information is sent in the control plane to the first cell station, as for example no Scheduling Requests are sent directly to the first cell station. This may be done for example by just preventing using the resources (frequency carrier, time slots, and/or codes (e.g. scrambling, channelization or spreading codes depending on the system type) or the like) normally dedicated for transmission to the first cell station. In another example, transmitting on these resources may be rendered ineffective by actively limiting the transmission range by preventing transmission power over a threshold. This threshold would typically be lower than the maximum transmission power achievable in the first operation mode.

In a first variant of the first aspect of the invention, the receiver is further adapted to receive a third downlink signal sent by the first cell station and carrying third downlink control information, said third downlink control information including at least an indication of an upcoming downlink resource on which user data transmitted by the first cell station is to be received, and wherein the controller is adapted to configure the receiver for receiving said user data. This variant is also applicable to the previously discussed variant.

Upon receiving the user data, the wireless terminal may decode it. The controller may then generate uplink information that can include an acknowledgement message based on the determination of whether the user data has been successfully decoded, said acknowledgement message being transmitted by the transmitter to the first cell station using e.g. the allocated uplink resource indication by the second configuration parameter when the controller operates in the direct operation mode or to the relay station using first configuration parameter, such as first resource when the controller operates in the TX-limited operation mode.

In a second variant of the first aspect of the invention, which can be combined with any of the previously discussed variants of the invention, the wireless terminal includes a buffer memory configured for buffering uplink data to be transmitted, and wherein the uplink information includes a buffer status report indicative of the amount of uplink information currently buffered in the buffer memory.

Thus, a buffer status report (BSR) in the second mode of operation is transmitted indirectly to the network via the relay station which then forwards the BSR to its respective serving cell station. A buffer status report is typically a MAC control element which is indicative of the amount of buffered data waiting for transmission for one or more logical channel or logical channel groups. This enables the network scheduler to grant resources for transmission according to the needs of the wireless terminal. This BSR can have different formats depending for example on the size of the resources available for transmission of the BSR itself, or on whether the BSR is transmitted over uplink or Sidelink.

In an alternative to the second variant, the buffer status report is received by the relay station, which then processes it. Such processing may include generating a new buffer status report, for example representative of the amount of data of the relay station and the wireless terminal, or the corresponding expected needs of resources. In another example, the newly generated buffer status report is representative of the accumulated amount of data in the respective buffers of some or all of the wireless terminals for which the relay station acts as a relay (or the corresponding needs of resources).

In a third variant of the first aspect of the invention, which can be combined with any of the previously discussed variants of the invention, the uplink information includes at least one uplink user data packet, wherein the user data packet is sent directly to the first cell station in the second operation mode and wherein the user data packet is to be forwarded by the relay station to the second cell station in the first operation mode.

As explained earlier, this respective serving cell station may be the first cell station if the relay station and the wireless terminal are included in the same cell and served by the same cell station. It is however possible that the respective serving cell station is a different cell station. Also, it is important to note that the relay station may forward messages indirectly to the network through at least one or more further relay stations in some more advanced examples of the invention. The BSR can be included with the transmission of the user data packet.

In a fourth variant of the first aspect of the invention which can be combined with the third variant, the receiver is adapted to receive further downlink control information including an indication of whether the uplink user data packet is decoded successfully.

Thus, after transmission of a user data packet (such as application layer information, IP packets), or control message (such as BSR), to the relay station, the relay station forwards the user data packet or control message to the network for example to the second cell station to which it is connected. As explained earlier, the second cell station may in fact be the first cell station, for example if the relay station is in the first cell, or a distinct station if the relay station is located in a different cell. The second cell station receives the user data packet or control message and may decode it or may verify the integrity of the user data packet or control message (e.g. using a Cyclic Redundancy Check (CRC), a Message Authentication Code or a Message Integrity Code). In an exemplary embodiment, if the message is received correctly and/or decoding is successful, the second cell station causes the first cell station to send an acknowledgement to the wireless terminal. This may imply transmitting over a backhaul channel (e.g. through the X2 interface linking the cell stations or through the Core Network) the instructions of transmitting the acknowledgement. Alternatively, the second cell station forwards the received user data packet or control message to the first cell station, which may decode it or may verify the integrity, and if successful generate the acknowledgement. Since the acknowledgement can be received directly from the first cell station, the wireless terminal does not need to sense the control resources from the relay station to obtain the acknowledgement. It is however to be noted that the HARQ timer (causing retransmissions if expired without positive acknowledgement reception) may need to be adapted to this forwarding architecture. As an example, this HARQ timer may be a function of the number of hops required to reach the first cell station (i.e. including the backhaul link). Or as another example, HARQ-based retransmissions may not be sent by the wireless terminal and instead only PDCP layer or IP layer based retransmissions are sent.

It is also possible that the user data packet or control message is first acknowledged by the relay station, for example, at the MAC level only to indicate that the first hop of transmission was successful. A higher layer (e.g. PDCP layer or Application layer) acknowledgement may be transmitted directly and separately from the first cell station after the user data packet has been forwarded by the relay station.

In accordance with a second aspect of the invention as claimed in claim 12, it is proposed a cellular communication system comprising
at least one first cell station, said first cell station serving a first cell,
at least one relay station served by a second cell station serving a second cell,
a wireless terminal served by the first cell station,
wherein the first cell station comprises a first cell station transmitter for transmitting directly to the wireless terminal a first downlink signal and carrying first downlink control information, said first downlink control information including at least an indication of a first configuration parameter to be used by the wireless terminal for transmitting a signal to the relay station,
wherein the second cell station comprises a second cell station transmitter for transmitting to the relay station a second downlink signal and carrying second downlink control information, said second downlink control information including at least an indication of a second configuration parameter to be used by the relay station for receiving the signal from the wireless terminal,
wherein the first and second configuration parameter at least partially overlap, the wireless terminal comprising a wireless terminal controller adapted to generate uplink information, and a wireless terminal transmitter configured by the wireless terminal controller to transmit to the relay station using the first configuration parameter a message carrying the uplink information,
the relay station comprising a relay station receiver adapted to receive said message using the second configuration parameter.

Thus, in accordance with this second aspect of the invention, the first and second configuration parameter, which may for example be first and second resource, or some other parameter values at least partially overlap. In some of the variants of this second aspect, the first and second resource correspond to one another. However, it is possible in some exemplary embodiments of the invention that the second resource is in fact a large set of resources, for example a resource pool, to be monitored by the relay station. In which case, the first resource may be included in the second pool, i.e. one resource element out of the resource pool.

However, in some further variants, the first cell station and the second cell station may use different (e.g. own) time/clock references that may differ slightly. This means that the first resource and second resource may be misaligned. In this case, this could result for example in the second resource being slightly too short in time i.e. they end at a time t1, whereas transmission in the first resource end at a time t2, and t1<t2. Conversely, second resource may start slightly too late in time i.e. they start at a time t3, whereas transmission in the first resource start at a time t4, and t3>t4. These examples may cause the relay station to miss a part of the transmission. Some counter-measures may be added to counter this problem. As an example, the wireless terminal may repeat its transmitted message multiple times. Also, if configured so, the relay station starts receiving slightly earlier than its signaled resource slot to account for the clock differences.

Alternatively, the first cell station may emit time sync signals that the wireless terminal can receive, while the relay station also emits its time sync signals that the wireless terminal can receive. Thus, it is possible for the wireless terminal to adjust a time offset between downstream communication and upstream communication (e.g. sent over Sidelink), so that it can be in sync with the time reference of the first cell station for receiving and the time reference of the relay station for transmitting.

Another solution for this above mentioned problem of different time references is the use of signaled resources being slightly different (e.g. in length) than the actual resources used. For example, in the case the first cell station and the second cell station use a different resources configuration/numerology.

In an alternative and more specific definition of the second aspect of the invention, the wireless terminal controller is configured to operate alternatively in accordance with a first operation mode (direct operation mode) and a second operation mode (TX-limited operation mode), and the wireless terminal comprises a wireless terminal receiver adapted in the direct operation mode to receive first downlink signals sent directly by the first cell station and carrying respective first downlink control information, wherein at least one of the respective first downlink control information includes at least an indication of a first allocated uplink resource to be used by the wireless terminal transmitter for transmitting a first uplink signal directly to the first cell station and at least one of the respective first downlink control information includes at least an indication of a first allocated downlink resource to be used by the wireless terminal receiver for receiving a further downlink signal directly from the first cell station, and in the TX-limited operation mode to receive second downlink signals sent directly by the first cell station and carrying respective second downlink control information, wherein at least one of said respective second downlink control information includes at least an indication of a second resource to be used by the wireless terminal transmitter for transmitting a second signal directly to the relay station and at least one of said respective second downlink control information includes at least a second allocated downlink resource to be used by the wireless terminal receiver for receiving a further downlink signal directly from the first cell station, the controller being adapted to generate uplink information, and wherein in the direct operation mode, the wireless terminal transmitter is configured by the wireless terminal controller to transmit to the first cell station on the first allocated uplink resource for direct communication to the first cell station, and the wireless terminal receiver is configured by the wireless terminal controller to receive the further downlink signal directly from the first cell station on the first allocated downlink resource; and
wherein in the TX-limited operation mode, the wireless terminal transmitter is further configured by the wireless terminal controller to transmit to the relay station on the second resource the second signal carrying the uplink information, said uplink information to be forwarded to the second cell station, and the wireless terminal receiver is further configured by the wireless terminal controller to receive the further downlink signal directly from the first cell station on the second allocated downlink resource.

In accordance with a second variant of the second aspect of the invention, which may be combined with the first variant, the relay station comprises a relay station transmitter for transmitting to the second cell station a relayed message including said uplink information.

In accordance with a third variant of the second aspect of the invention, which may be combined with the first or the second variants, the second cell station is adapted to transmit to the relay station a third downlink signal and carrying third downlink control information, wherein said third downlink control information includes at least an indication of a third configuration parameter to be used by the relay station for transmitting the relayed message to the second cell station.

Thus, the network is able to fully control and schedule the resource allocated for transmission from the wireless terminal to the network, and thus allocates resources for each hop of the transmission until the cell station for example. This means that the whole path (including multiple hops if multiple relay stations are used) can be reserved for the transmission by the network scheduler typically located in the cell stations. Depending on the architecture, the second cell station may control all the uplink allocation from the relay station to the network.

As previously mentioned in relation with the first aspect of the invention, the first cell station and the second cell station may be a single cell station.

In accordance with a fourth variant of the second aspect of the invention, it is possible that the first downlink signal and the second downlink signal are a single downlink signal being received at the wireless terminal and at the relay station. Thus, this reduces even further the control signalling required for the allocation of the resources for the message transmission.

Similar to the fourth variant, and possibly in combination with it, the second downlink signal and the third downlink signal may also be a single downlink signal being received at the relay station. This reduces even further the allocation signalling, since a single signal is used for the allocation of the whole upstream path.

In a fifth variant of the second aspect, which may be combined with any of the previously discussed variants, the relay station comprises a relay station controller to determine whether the message has been received correctly (e.g. by verifying the integrity of the received message) and/or decoded correctly (e.g. by the relay station itself or by the second cell station) and a relay station transmitter configured by said controller to transmit an acknowledgement message to the wireless terminal indicative of whether the message has been received and/or decoded correctly.

In a sixth variant of the second aspect, which may be combined with any of the previously discussed variants, the message carrying the uplink information includes at least one uplink user data packet to be forwarded by the relay station to the second cell station.

In a seventh variant which can be combined with the sixth variant, the first cell station transmitter is adapted to transmit an acknowledgement message indicative of the correct decoding of the message by the second cell station or the first cell station.

In accordance with a third aspect of the invention, it is proposed a relay station as claimed in claim 18, the relay station operating in a cellular communication network comprising at least one first cell station, said first cell station serving a first cell and a wireless terminal served by the first cell station,
the relay station served by a second cell station serving a second cell,
the relay station comprising
a relay station receiver adapted to receive from the second cell station a second downlink signal carrying second downlink control information, said second downlink control information including at least an indication of at least one first configuration parameter for receiving a message from the wireless terminal,
a relay station controller for controlling the relay station receiver to receive said message including uplink information on the first configuration parameter,
and a relay station transmitter adapted for forwarding the uplink information in a relayed-data message to the second cell station.

It is to be noted that the relayed-data message may contain control information and/or user data. Besides, the relayed-data message may include the uplink information itself (which can be control information and/or user data as well) or information that is the result of some processing of the uplink information, including for example combination with other information as will be explained in the following embodiments.

In a first variant of the third aspect of the invention, the relay station receiver is adapted to receive from the second cell station a third downlink signal carrying third downlink control information, wherein said third downlink control information includes at least an indication of an allocated uplink resource to be used by the relay station for transmitting the relayed message to the second cell station.

In a second variant of the third aspect of the invention, which may be combined with the first variant, the relay station controller is adapted to determine whether the message has been received correctly (e.g. by verifying the integrity of the received message) and/or decoded correctly (e.g. by the relay station itself or by the second cell station) and the relay station transmitter is configured by said relay station controller to transmit an acknowledgement message to the wireless terminal indicative of whether the message has been received and/or decoded correctly.

In accordance with a fourth aspect of the invention, it is proposed a first cell station serving a first cell as claimed in claim 19 in a cellular communication system comprising
at least one relay station served by a second cell station serving a second cell,
a wireless terminal served by the first cell station,
the first station cell station comprising
a first cell station transmitter for transmitting to the wireless terminal a first downlink signal carrying first downlink control information, said first downlink control information including at least an indication of a first configuration parameter to be used by the wireless terminal for transmitting a message to the relay station,
a first cell station controller for configuring the relay station with second downlink control information, said second downlink control information including at least an indication of a second configuration parameter to be used by the relay station for receiving the message from the wireless terminal, wherein the first and second resource at least partially overlap.

In a first variant of the fourth aspect of the invention, the configuring by the first cell station controller of the relay station includes the first cell station causing the second cell station to transmit a second downlink message including said second downlink control information to the relay station.

It is however to be noted that, like for the other aspects of the invention, the first cell station and the second cell station may be a single cell station. This may for example be the case if the wireless terminal and the relay station are served by the same cell.

In accordance with a fifth aspect of the invention, it is proposed a method as claimed in claim 20 for operating a wireless terminal to communicate in a cellular network, said cellular network comprising at least one first cell station, said first cell station serving a first cell, and at least one relay station served by a second cell station serving a second cell,
the method comprising the steps of
the wireless terminal receiving a downlink signal sent by the first cell station and carrying downlink control information, said downlink control information including at least an indication of a first configuration parameter to be used by the wireless terminal for transmitting a message to the relay station,
the wireless terminal generating uplink information,
the wireless terminal transmitting to the relay station using the first configuration parameter the message carrying the uplink information, wherein said uplink information is to be forwarded to the second cell station.

In accordance with a seventh aspect of the invention, it is proposed a computer program product comprising code means for producing the steps of the method of the sixth aspect of the invention when run on a computer device.

It is noted that the above apparatuses may be implemented based on discrete hardware circuitries with discrete hardware components, integrated chips, or arrangements of chip modules, or based on signal processing devices or chips controlled by software routines or programs stored in memories, written on a computer readable media, or downloaded from a network, such as the Internet.

It shall be understood that the wireless terminal, the system, the relay station, the cell station and the method may have similar, corresponding and/or identical preferred embodiments, in particular, as defined in the dependent claims.

It shall be understood that a preferred embodiment of the invention can also be any combination of the dependent claims or embodiments with the respective independent claim.

These and other aspects of the invention will be apparent from and elucidated with reference to the embodiments described hereinafter.

### BRIEF DESCRIPTION OF THE DRAWINGS

FIG. 1A already described is a block diagram representing a network in which the invention can be implemented;

FIG. 1B is a block diagram representing a multi-hop network in which the invention can be implemented;

FIG. 2A is a block diagram representing the layer model of the user plane in accordance with a relaying architecture;

FIG. 2B is a block diagram representing the layer model of the control plane in accordance with the relaying architecture;

FIG. 3 is a block diagram representing a network using a cell station multi-hop relaying architecture;

FIG. 4 is a block diagram representing a network in accordance with a first embodiment of the invention;

FIG. 5 is a flow chart representing the operation of the network of the first embodiment;

FIG. 6 is a block diagram representing a wireless terminal in accordance with the first embodiment;

FIG. 7 is a block diagram representing a relay station in accordance with the first embodiment;

FIG. 8 is a block diagram representing a cell station in accordance with the first embodiment;

FIG. 9 is a block diagram representing a network in accordance with a second embodiment of the invention;

FIG. 10 is a block diagram representing a network in accordance with a third embodiment of the invention;

FIG. 11 is a block diagram representing a network in accordance with a fourth embodiment of the invention;

FIG. 12 is a block diagram representing a network in accordance with a fifth embodiment of the invention; and

FIG. 13 is a block diagram representing a network using Dual Connectivity.

### DETAILED DESCRIPTION

In the following, the embodiments will be described in the context of a 3GPP cellular network, although these embodiments may be applied to other types of networks. As explained earlier, the cell is served by a cellular base station, referred to in 3GPP as “eNB” (4G term) and “gNB” (5G term). The eNB/gNB is part of the Radio Access Network RAN, which interfaces to functions in the Core Network CN. A “UE” is “User Equipment”, the standard name in 3GPP for a wireless client device or a specific role played by such device. The term “node” is used to denote either a UE or a gNB/eNB. “NF” denotes a Network Function in the CN.

“Indirect network connection” is as defined in TS22.261. “D2D” is Device-to-Device communication, and “PC5” is the interface to use Sidelink communication as defined by V2X (TS TS 23.287) or ProSe (TS23.303, TS 23.304 and in TS38.300). “UL” is used for uplink Uu communication as defined in TS38.300, “DL” for downlink Uu communication as defined in TS38.300, and “Sidelink” or “SL” for Sidelink communication as defined in TS38.300.

In the following description, “upstream” or “uplink” is used for a data flow destined towards a cell station, for example a gNB, while “downstream” or “downlink” is used for a data flow from a gNB destined towards a UE in the RAN. “User Data” is used for any type of user data or application data that is not related to management or operation of cellular network functions (typically at the IP layer or above the IP layer). An upstream transmission may involve an indirect network connection via one or more relay stations, whereby a signal/message first will be sent to a relay station after which the relay station may forward the signal/message to the gNB. A relay station may support an UL (Uu interface) and/or a SL (PC5 interface). Thus, upstream transmission may happen on UL (Uu interface) and/or on SL (PC5 interface) depending on network configuration and context; Since in the context of this patent application the wireless terminal is able to receive signals/messages directly from the cell station (even when it operates in a limited transmission mode for sending upstream signals/messages), unless stated otherwise, we use the term ‘downlink’ typically for transmissions on DL (Uu interface), and the term ‘downstream’ typically for indirect communication via a relay station, whereby the transmission may also happen on SL (PC5 interface) depending on network configuration and context.

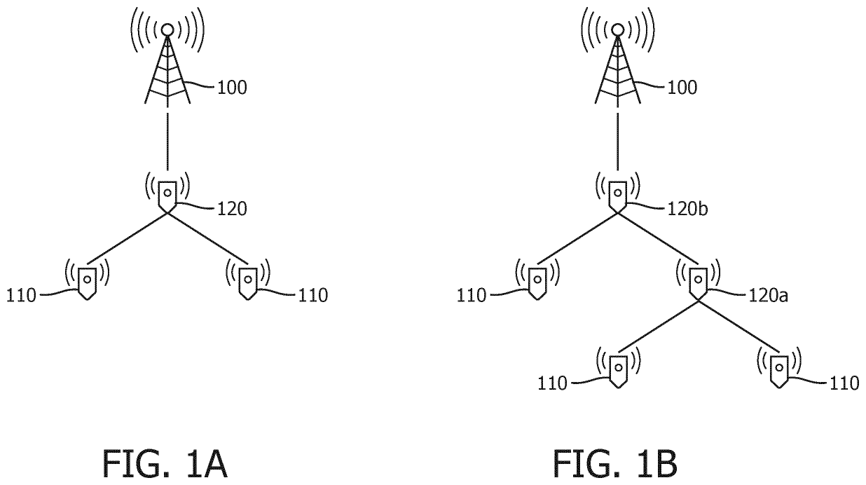

In a cellular network in which the invention is implemented, as mentioned earlier in reference to FIG. 1A, each cell 10 is served by a base station 100. A plurality of secondary stations are located in the vicinity of the cell 10 and of the base station 100. At least some of these secondary stations can communicate directly with the base station 100. Further, some of the secondary stations can act as relay stations 120 as they include functionalities to relay communication between a base station 100 and another secondary station 110. This relay function for example helps to extend the coverage of a cell 10 to an out-of-coverage (OoC) secondary station 110. The relay station 120 may be a mobile station (e.g. a UE) or could be a different type of device. This cellular network may for example be a 4G or a 5G network or some other type of cellular networks. As 4G and 5G networks include the possibility of relaying by UEs including the Sidelink functionalities, the relay station 120 and the secondary station 110 of FIG. 1A may be in this example UEs that include Sidelink functionalities. While FIG. 1A is limited to a single hop architecture, the various embodiments of the invention herein described could also be adapted to the case of a multi hop architecture as shown on FIG. 1B.

Communicating directly with the base station has some drawbacks or may not even be possible for some periods. Direct communication with a base station may require a high energy consumption and/or high energy peaks to transmit a message with sufficient radio transmission power, which is not acceptable for a (wireless, typically battery-powered) wearable UE or IoT UE. Sometimes, the conditions may even worsen (due to interference or additional fading) rendering the transmission impossible. Indeed, a UE (e.g. IoT device) may have a limited radio transmission power, such that the base station (gNB) cannot be reached anymore using the available and/or selected transmission mode(s) when the UE is far away, moves out of range, and/or is subject to interference or new obstacles on the transmission path. In the meantime, the UE may still receive the transmissions from gNB despite the degraded conditions, for example thanks to more flexible and robust transmission modes, or higher available transmission power, in the gNB.

The current solutions defined in 3GPP allow a wireless terminal acting as a fully-OoC or partly-OoC Remote UE (e.g. a Remote UE that is intermittently Out of Coverage, or for which transmission to the cell station (e.g. a gNB) may lack sufficient signal quality leading to many retries or lost messages) to communicate via a relay station acting as a Relay UE for sending upstream data or receiving downstream data. However, all the communication with the Remote UE takes place over Sidelink (SL) channels currently using a self-scheduling method of resource selection (Mode 2) for the Remote UE. This self-scheduling has some issues:
It requires the Remote UE to extensively “sense” the designated Sidelink time/frequency resources to determine when it can transmit to the Relay UE or receive messages from the Relay UE. This sensing leads to increased energy consumption. This high energy consumption of a (wireless, typically battery-powered) wearable UE or IoT UE is not satisfactory due to the limitations of portable devices, and in particular for IoT devices.
It constrains the Remote UE to use only preconfigured resources, a so-called Sidelink resource pool, for its Sidelink transmissions to the Relay UE while in fact there may be further, more optimal resources available but for which the Remote UE is currently not authorized for usage.
Additionally, the Remote UE has to compete for (potentially scarce) Sidelink resources with other UEs that are out-of-coverage (for example, other OoC Remote UEs attached to the same Relay UE), or OoC UEs that depend on Sidelink communication for their applications e.g. ProSe D2D or V2X D2D applications. Many users of Sidelink spectrum resources combined with the self-scheduling approach (with no central orchestration by gNB for OoC UEs) could lead to increased radio transmission collisions and an increased probability of failed transmissions to/from the Relay UE.
The potentially limited bandwidth available for downstream data (via a Relay UE) to an indirectly connected Remote UE may not provide sufficient downstream data capacity in certain cases.
a. E.g. one reason for this bottleneck may be that the resources allocated for Sidelink (SL) communication, needed by the Relay UE to send the data to the Remote UE, is a very limited subset of the total set of cellular resources available.
b. Another reason may be that the Relay UE needs to serve other Remote UEs at the same time so the scarce resources (spectrum, processing time, buffer memory, etc.) of the Relay UE need to be divided across multiple devices. Other Remote UEs may have higher priority to be served by the relay.
Further, if the Relay UE needs to, or would like to, apply DRX features for power saving, then it could happen that the Remote UE transmits to the Relay UE at the time that the Relay UE is in its DRX sleep/inactive state, or that the Remote UE has to wait until the time of the DRX active state of the Relay UE before transmitting. This could lead to an increased latency or even some loss of data.
Possible packet collision due to overlapping resource allocations (mode 2) when Remote UE is out of coverage and thus the resources for Remote UE to transmit on are not scheduled.

A known solution to schedule SL resources for a Relay UE directly connected to gNB is described in TR37.985 v16.0. The gNB sends a DCI Format 3_0/3_1 message to the Relay UE, which can then transmit in SL on the indicated resources. However, the inventors of the current invention recognize the following disadvantages to this known solution:
a Remote UE is not aware of the scheduled resources, because the DCI message is directed towards the Relay UE only. Therefore, the Remote UE doesn't know when to be ready to receive on SL from the Relay UE.
This known solution cannot be used to schedule resources for the Remote UE for transmission. Indeed, in current specifications, no scheduling messages are being sent to OoC UEs—including partly-OoC UEs such as transmission-limited UEs (as will be explained later in further details). So the Remote UE doesn't know when/how to best transmit on SL such that the Relay UE will receive it; and it can do no better than self-scheduling.

The proposed embodiments of the current invention overcomes these disadvantages by defining a scheduling and data transmission method such that both Relay UE and Remote UE are informed about the resources to use for communication, for example under a situation of limited connectivity of the Remote UE.

By limited connectivity, it is to be understood that this can be due to the external conditions of the Remote UE as well as a design/operation choice. For example, a Remote UE may experience limited connectivity because of its location (for example edge of the cell, or in a building) such that a direct uplink transmission to the base station may be too costly in terms of energy or power or because of its capacities (low remaining battery charge, low-power device like an energy-harvesting terminal), or would lead to many retries or lost messages due to insufficient signal quality. In another example, the Remote UE may be used in a location where the transmission levels are not allowed to exceed a threshold (hospitals, labs where radiation levels have to stay within a given range). These limitations would correspond to a Tx-limited wireless terminal, that is not able (or prefers not) to transmit directly to the cell station.

Such an asymmetric situation of not being able to transmit back may occur due to specific Tx limitations in the wireless terminal (or Remote UE)—such as one or more of the following specific examples:
1. Maximum allowed peak current drain from the wireless terminal battery, e.g. due to small battery form factor such as coin cell or due to the specific chemistry of the battery.
2. Maximum allowed transmit power of the wireless terminal radio, e.g. due to using a low-cost/low-power/compact-form-factor radio module.
3. Limited duty cycle available for high-power transmissions, e.g. if the high-power Tx mode is powered by an (ultra)capacitor that is charged via an output-current-limited battery or through energy harvesting.
4. Suboptimal antenna design, e.g. limited number of antennas, or low effective radiated Tx power due to small form factor of the wireless terminal. While the cell station may compensate this limitation by increasing its transmission power and/or increasing signal repetitions or other means, the wireless terminal may not be able to compensate due to one or more of the limitations 1, 2, 3 or 8.
5. Suboptimal placement of device which hampers the wireless terminal transmissions, e.g. implantable UE or M2M module located in a basement, deep indoors, etc. While the cell station may compensate this limitation by increasing its transmission power and/or increasing signal repetitions or other means, the wireless terminal may not be able to compensate due to one or more of the limitations 1, 2, 3 or 8, or because the location (e.g. human body) limits transmission power due to regulations.
6. Inability to perform (effective) Tx beam steering towards the cell station, e.g. due to low number of antennas or limited capacity for signal processing on the wireless terminal. While the cell station may compensate this limitation by increasing its transmission power and/or increasing signal repetitions or other means, the wireless terminal may not be able to compensate due to one or more of the limitations 1, 2, 3 or 8.
7. In general the “asymmetry” aspect of the cell station transmitter vs the wireless terminal transmitter.
8. Limited support in the UE for coverage extension modes, such as increasing the number of repetitions of sending a message to the cell station.
9. Transmit and receive frequencies may be different (e.g. as in FDD) or modulations for transmit/receive signals may be different, leading to different link budget for transmission versus reception.
10. The wireless terminal having limited energy for transmission (e.g. remaining battery power low or energy harvesting capacitators not fully filled up yet), but still having an urgent/important message to be transmitted (e.g. an emergency SMS).

Therefore, as explained above, one aim of the current invention in the case of a Tx-limited wireless terminal is to solve the above issues for the specific case that a wireless terminal is able to receive the transmissions from a cell station (i.e. channels on DL) but either is not physically able to transmit back (i.e. via UL); or is in principle able to transmit back but doesn't do this in order to conserve energy usage or for other reasons (e.g. possible local use rules).

Conversely, limited connectivity may also include Rx-limited stations which are able to transmit directly to the cell station, but cannot receive directly. This can be due to a low sensitivity receiver or local interference (e.g. coexistence with a Wi-Fi network near the wireless terminal).

The “asymmetry” aspect mentioned in point 7 above is about the differences in the transmitters of the cell station vs the wireless terminal transmitter, which in some situations could make it more likely that a cell station can transmit to a wireless terminal than vice versa due to:
1. High power (dBm) for transmission available in the cell station vs low power in the wireless terminal;
2. Different frequency bands used for transmission and reception, leading to a higher link budget for downlink than for uplink;
3. Mains-powered cell station vs battery-powered (or energy-harvesting powered) wireless terminal.

In view of these cases, it is recognized by the inventors that the above list of limitations will be relatively common cases in the future when 5G is increasingly adopted in wearables, low-power, and IoT devices.

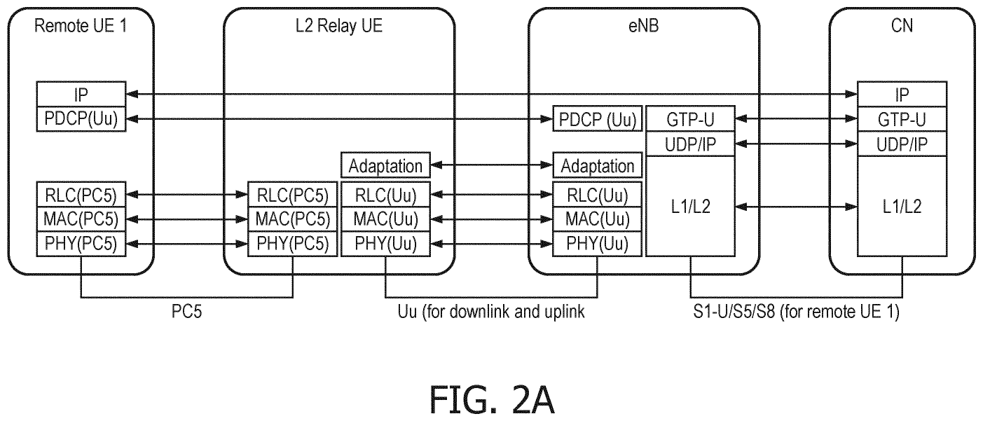

Other work in 3GPP discussed in TR23.733 and TR36.746 include studies on architecture enhancements e.g. to enable a wireless terminal such as an IoT device (in a role of Remote UE) to operate on very low power by using a relay station acting as a Relay UE to connect to the wider network. Because the Relay UE is physically very close, it can be reached using very low power transmissions. These discussions lead to some new relaying architectures, including a Layer 2 (L2) Relaying architecture. Layer 2 in the OSI model corresponds to the Data Link Layer or Radio Layer 2 in 3GPP (RLC, MAC, PDCP), while Layer 3 in the OSI model corresponds to the Network Layer (Internet Protocol Layer). This L2 Relaying architecture, unlike ProSe 4G relaying which operates at application layer (L3, roughly at the Internet Protocol IP layer), is intended to offer end-to-end IP packet and PDCP packet transmissions to and from wireless terminals as shown on FIG. 2A for the user plane stack. Similarly L2 Relaying is proposed for the control plane data, as can be seen on FIG. 2B for the control plane stack.

Such an architecture enables the wireless terminal acting as a Remote UE to become directly visible as a registered entity in the Core Network. This provides some advantages for applications like monitoring or billing and for improved control by the cell station over the wireless terminal. Additionally, the wireless terminal can access all functions of the Core Network, as if it were directly connected. It is to noted that alternative relaying architectures exist such as in TR23.752, a proposal for Layer 3 (L3) relaying in ProSe 5G (user plane only), and which is very similar to how it was in 4G. Also other types of relay devices have been discussed or are being discussed, such as using a UE as a gateway UE (e.g. mobile phone or residential gateway) for relaying the traffic of personal IoT devices (e.g. wearables, in-home devices) to the 5G network (see e.g. TR 22.859).

In addition, 3GPP is also working on new features discussed under TR38.874 for Integrated Access and Backhaul (IAB), to enable relaying between cell stations. The purpose of IAB is to make it easier to extend the coverage area of a 5G radio access network through the deployment of additional intermediate wirelessly connected cell stations or small cells. The main difference with UE-based relay (like Sidelink) is that in IAB the devices are highly sophisticated devices with lots of resources, whereas in UE-based relay the wireless terminals could be very low power resource constrained devices with very little resources to spare to act as relay stations. Also, in IAB the cell stations are typically owned and operated by the same network infrastructure provider, whereas with UE-based relays, relay stations acting as Relay UEs will typically be owned by many different individuals, which may have different subscriptions to different mobile network operators. Furthermore, for Relay UEs, the mobile network operators want full authorization control of which UEs can act as Relay UE and which Remote UEs and Relay UEs are allowed to access the mobile network, whereas in IAB this is integrated seamlessly in the core network. Mobile network operators also want full control of the resources/frequencies that a Relay UE can use for Sidelink communication with a Remote UE, whereas in IAB the intermediate nodes have more autonomy in scheduling resources for downlink devices. Note that in some cases (e.g. 3GPP is also discussing the use of vehicle mounted IAB nodes (see e.g. TR 22.839)), some of these characteristics and procedures (e.g. ownership, authorization, resource allocation) may be more similar to Relay UEs than to base stations.

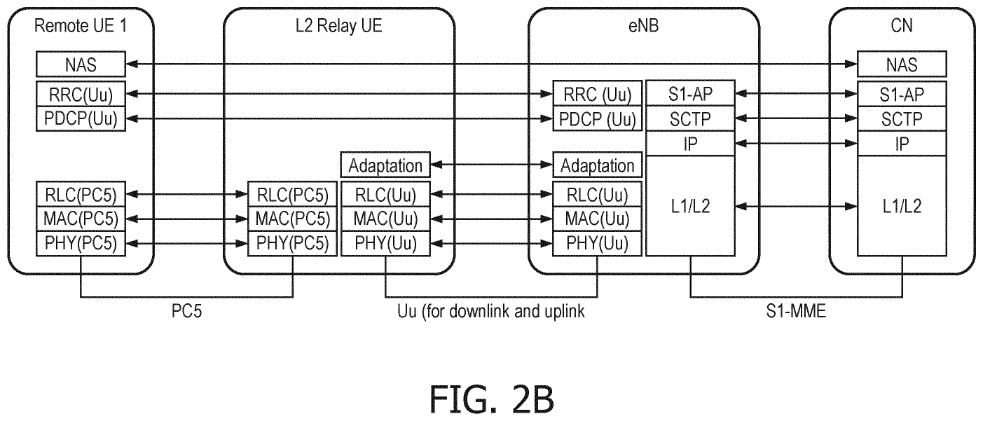

As shown in FIG. 3, this architecture uses mechanisms similar to ProSe Relay where the IAB-node can relay traffic for other IAB-nodes towards the IAB-donor. The communication between IAB-nodes uses the 5G defined interface “F1” as defined in TS38.473 between a base station Central Unit (CU) and its linked Distributed Unit (DU) which is used in general for distributed cell stations. For registration and some control information, and IAB node also includes a mobile terminal/UE component.

However, these improvements fail to solve all the problems mentioned earlier linked to the Sidelink scheduling on one hand and the direct communication with the base station which require high energy consumption and may not be reliable on the other hand.

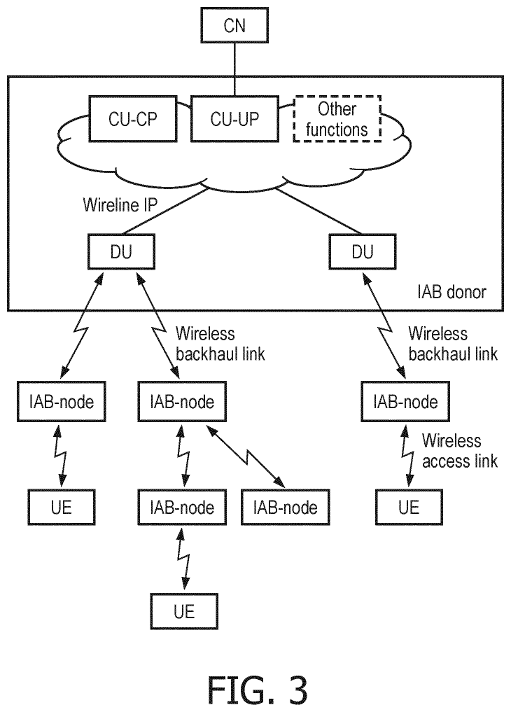

Thus, in accordance with a first embodiment of the invention, it is proposed a cellular network as shown on FIG. 4 comprising a cell station 400, e.g. a gNB 400 serving a cell 40. A plurality of secondary stations are included in the cell. A first type of the secondary stations 410 may be secondary stations that experience (or require) a limited connectivity. In this embodiment, this limited connectivity corresponds to a transmission limitation as explained earlier, in the sense that direct transmission to the cell station is hindered (or prevented). This first type of secondary stations are wireless terminals, for example Remote UEs 410. A second type of secondary stations, in this example also in the first cell, acts as relay stations 420, i.e. they have sufficient capacities and suitable functionalities to act as a relay between the cell stations and other secondary stations. These relay stations 420 may be between the cell station 400 and secondary stations of either the first type, i.e. wireless terminals 410 or even the second type (i.e. relay stations 420) in the case of a multi-hop system (not shown in FIG. 4). This relay station 420 may act as a Relay UE 420 for the upstream flow only. This first embodiment allows upstream data flow 411 and downlink data flow 401 (e.g. including both data traffic and control information for example sent over respective channels). In accordance with this embodiment, the direct radio link 401 from the cell station 400 to the wireless terminals 410 and the relay stations 420 (DL) is used for scheduling resources as well as announcing downlink data for the wireless terminals and the relay stations. The indirect link 411 between the wireless terminal 410 and the cell station 400 through the relay station 420 can be used for upstream data. Another downlink direct link 402 between the cell station 400 and the relay station 420 may be used to schedule the upstream resources (e.g. sidelink resources) to be used between the wireless terminal 410 and the relay station 420 on one hand, and the uplink resources to be used between the relay station 420 and the cell station 400 on the other hand. Besides, the relay station 420 uses its own uplink connection 403 for transmission to the cell station 400. In FIG. 4, this uplink connection 403 is direct to the cell station 400. However, in the case of a multihop relaying system, this uplink connection 403 may be indirect. It is to be noted that in the various following embodiments, the upstream link 411 may be logically included in the uplink connection 403 (allowing more flexibility in the connection). Alternatively, the operation of the various following embodiments can be adapted to keep the link 411 and the link 403 as distinct logical (or even physical) links.

It is thus proposed that a cellular wireless communication system includes at least one cell station 400; and at least one secondary station 420 acting as a relay station 420 (e.g. a Relay UE); and at least one a wireless terminal 410 (e.g. acting as a Remote UE). In this embodiment, the cell station 400 can transmit one or more communication resource reservation messages over the downlink direct links 401 and 402 to indicate at least one of
downlink resources, also referred to as “DLresources”, for a future downlink data transmission from the cell station 400 directly to the wireless terminal 410;
upstream resources, also referred to as “Us-resources”, for a future upstream data transmission from the wireless terminal 410 over SL and/or UL; and
upstream resources for reception by a relay station, also referred to as “Us-Rx resources”, for receiving an upstream data transmission typically over SL and/or on UL from the wireless terminal 410 at the secondary station 420 acting as a relay station 420.

The uplink and upstream resources may be the same or based on the same resource pool, or may be based on separate resource pools. The uplink and upstream resources may not be distinguishable by the wireless terminal 410 or relay station 420 (this may e.g. be the case when uplink resources are shared (as depicted later) with the relay station to enable the relay station 420 to operate on behalf of the cell station). However, typically uplink and upstream resources are distinguishable, whereby the cell station can indicate which type it is, e.g. by using a different DCI format or different RRC message. As an option (that may be applied to any other embodiment), the first cell station may schedule both direct uplink resources (e.g. for communication via Uu interface) as well as upstream resources (e.g. for communication to the relay station for example via sidelink) for the wireless terminal 410, and/or send information about both the uplink resources and the upstream resources to the wireless terminal in the first message and/or send configurations information about conditions or thresholds in which circumstances to use the uplink resources and in which to use the upstream resources. A wireless terminal that receives both sets of resources may send a copy of its messages/signals in both the uplink resources and the upstream resources, or may select which resources to use based on the configuration information received from the cell station about the conditions or thresholds to apply, or based on pre-configured conditions or thresholds (e.g. stored in the USIM). These conditions/thresholds may be the same or overlapping with the conditions/thresholds based on which the wireless terminal determines that it operates or needs to operate in TX-limited mode. If the wireless terminal has determined to operate in TX-limited mode, it will use the upstream resources to communicate with the relay station rather than using the uplink resources, and may adjust its transmit power depending on whether uplink resources or upstream resources are used and/or whether it is configured by the cell station with uplink or upstream resources. The cell station may configure the wireless terminal (e.g. through a control signal/message, for example as part of a SIB, RRC or DCI signal/message or as part of UE policy information) with information on transmit power limits (e.g. minimum or maximum) and/or recommended transmit power to use for different (types of) resources (e.g. uplink over Uu or upstream over Sidelink), for different destinations (e.g. if a particular relay station is to be used, that may be identified through a given identifier), for different modes/circumstances/coverage levels/signal quality thresholds the device may operate in (e.g. wireless terminal operating TX-limited mode). The wireless terminal may use this configuration information to determine which transmit power to use.

It is to be noted that this architecture may be part of a special operation mode, and a different architecture, for example a conventional architecture with a direct duplex link between the wireless terminal and the cell station is normally in use. As will be detailed later, the operation conditions or some other events may trigger the network, the cell station, the relay station and/or the wireless terminal to operate with this special operation mode (i.e. TX-limited mode).

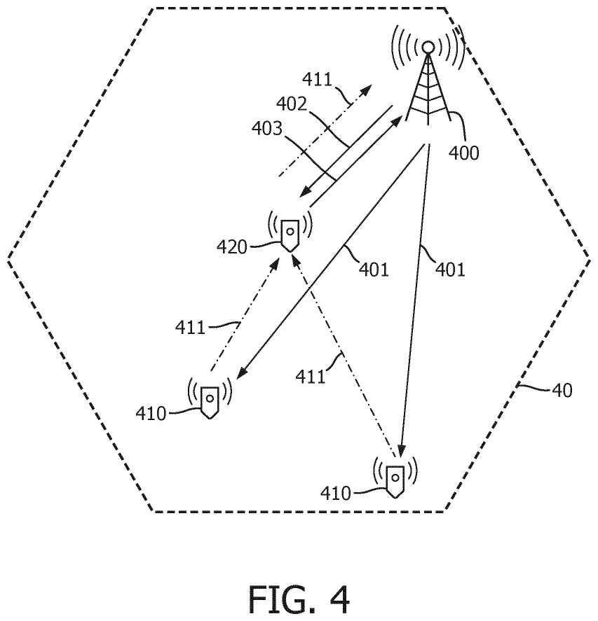

In any case, in accordance with this architecture, it is included a mechanism for operating the secondary station being a wireless terminal 410, e.g. a Remote UE, to communicate in the cellular network with the cell station 400. This first cell station 400 serves a first cell 40. Furthermore, in this cell, at least one other secondary station 420 can operate as a relay station 420. As depicted on FIG. 5, the mechanism includes the following steps:
S51: The first cell station 400 sends to the wireless terminal 410 a first message carrying first downlink control information, which may include an indication of an allocated upstream resource.
S52: The first cell station 400 sends to the relay station 420 at least one second message carrying second downlink control information. This second downlink control information, carried by one or more messages may include information on the upstream allocated resources on which the wireless terminal is meant to transmit its message to the relay station 420. It may also include a message for allocating resources to be used by the relay station 420 when forwarding the message.
S53: the first message is detected by the wireless terminal 410 which decodes the message to obtain the indication of the allocated upstream resource. This allocated resource can be used by the wireless terminal 410 for transmitting an upstream signal to the relay station 420.
S54: the wireless terminal 410 generates uplink information (i.e. information (e.g. user data) that would under normal bi-directional communication mode be transmitted directly to the gNB over Uu interface), that is included in a message, and uses the allocated upstream resource for transmitting to the relay station 420 the upstream signal carrying the message. It is to be noted that the uplink information is meant to be forwarded to the cell station 400. To this end, the uplink information may be appended/prepended/updated/multiplexed with information about the relay station (e.g. the L2 identifier or other identifier of the relay station) as part of the upstream message.
S55: The relay station 420 receives the message from the wireless terminal 410 on the upstream resource allocated by the cell station 400.
S56: The relay station 420 optionally processes the message if needed, and forwards the uplink information (or the upstream signal/message) to the cell station 400.

In this embodiment, only one cell station 400 is included however this mechanism can be adapted to the case where more than one cell station needs to operate. As will be detailed in a further embodiment, this is for example the case when the relay station is not served by the cell station 400 but by another station, for example if the relay station is located in a different cell. As will be detailed later, the first cell station 400 would take care of sending the message including the resource allocation (e.g. Us-resources and/or Ds-resources) to the wireless terminal 410, while a different station transmits the resource allocations e.g. UL resources and Us-Rx-resources (respectively for UL and incoming over SL from the wireless terminal) relative to the relay station 420.

It is to be noted that the message sent in step S51 and the message sent in step S52 may be merged (e.g. piggybacked or jointly coded in single message using a common identifier relative to both the relay station 420 and the wireless terminal 410). Alternatively, as described above these messages allocating resources for the wireless terminal 410 to transmit and for the relay station to receive may be sent over two separate messages decoded by both UEs. These messages can be sent by the first cell station 400 or in the case of two cell stations, by either one or the other, or each message by one respective cell station.

Furthermore, the first cell station 400 may signal upcoming downlink transmission directly to the wireless terminal. In an example, this signalling occurs in the same frame as the downlink transmission. Thus, the wireless terminal 410 can receive downlink data in DL-resources signaled by the first cell station, and transmits upstream data in the allocated Us-resources. This upstream data may include for example at least one of user data destined to flow into Core Network or beyond; or feedback data, e.g. acknowledgements (ACK/NACK), that describe the status of whether or not the wireless terminal 410 has correctly received downlink data that was previously sent by the first cell station 400 directly to the wireless terminal 410.

Optionally, the relay station 420 may send acknowledgement data (e.g. HARQ signals) to the wireless terminal 410 once the upstream signal of step S54 has been received. This acknowledgement data thus indicates the correct/incorrect reception of this data signal. To this end, the first cell station 400 may include for example in the second downlink control information of step S52 HARQ process information (e.g. HARQ process ID, timing/resource information). In an example, the relay station 420 can act on behalf of the first cell station for sending HARQ feedback information back to the wireless terminal 410. The first cell station may also provide (e.g. as part of the second downlink control information) some security credentials or information about the type, format, encoding, scrambling or content of the signals or messages to enable the relay station 420 to verify the integrity of the message or (partially) decode the message/signal, and may also provide instructions/policy information under which conditions (e.g. if the CRC or Message Integrity Code/Message Authentication Code is verified to be correct) the relay station 420 would be allowed to send acknowledgement data to the wireless terminal (410). The relay station 420 may use the information received from the first cell station to perform some processing on received upstream signals/messages from the wireless terminal 410, and may send acknowledgement data to the wireless terminal 410 if the outcome of that processing meets one or more conditions. Alternatively, the relay station 420 first forwards the received upstream signal/message (or uplink information which may be added to a different message after processing) to the first cell station, which (instead of sending acknowledgement data directly to wireless terminal 410) may send a signal/message to relay station 420 upon successful reception/decoding/integrity verification of the forwarded upstream signal/message (or different message containing the uplink information), whereby the relay station 420 may subsequently send acknowledgement data to the wireless terminal 410.

It is to be noted that the upstream signal in step S54 that is sent on the allocated Us-resources may be overheard by the first cell station 400 directly (e.g. if channel conditions are momentaneously better). Thus, the data sent on step S54 can in fact be transmitted directly to the cell station 400, and the link to the relay station 420 can act as a fallback should the direct transmission power level be insufficient. This is in particular relevant for the case where the wireless terminal 410 is at the edge of Tx-connectivity to the cell station 400 and its transmissions are sometimes received correctly by the first cell station 400. If so, the cell station 400 can directly process the upstream signal/message containing the uplink information. The cell station 400 may inform relay station 420 (e.g. through the second control signal) that the upstream signal (e.g. identified by its upstream resource or message identifier or other part of the message) has already correctly been received directly by the first cell station 400. The relay station 420 may then discard this message or avoid sending it to cell station 400 or avoid sending acknowledgement data to wireless terminal 410.

As mentioned in step S56, the relay station 420 can relay the received uplink data from the wireless terminal 410 upstream towards its upstream cell station, over one or more hops. For each hop there may be HARQ feedback. The uplink data is then eventually received by the first cell station 400. In case the data includes upstream User Data, the receiving cell station sends back feedback data e.g. ACK/NACK indicating whether the User Data was successfully received, directly to the wireless terminal 410 in a future downlink (DL) transmission using new Ds-resources. In case the user data has not been correctly received, feedback data e.g. NACK indicates to the wireless terminal 410 that at least a part of the data previously transmitted is missing. The cell station 400 may then directly schedule the retransmission of data by the wireless terminal 410. This can be done by allocating a future Us-resource. The retransmission is then possibly relayed through the relay station 420.

In a particular variant of this embodiment, the cell station may instruct the wireless terminal in a TX-limited state to operate with Sidelink mode 2 resource allocation (e.g. through a SIB/RRC message sent as part of the first or second downlink signals), upon which the wireless terminal in TX-limited state will use sidelink mode 2 resource allocation instead of scheduled upstream or uplink resources. In line with what is mentioned earlier, the wireless terminal may limit its transmit power or reduce its transmit power when using these mode 2 resources in TX-limited state.

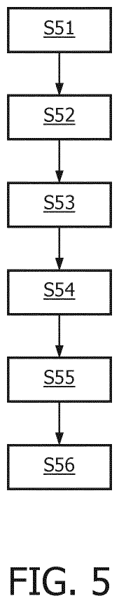

In accordance with the first embodiment, and now with reference to FIG. 6, the wireless terminal acting as a wireless terminal 410 typically includes an antenna 61 or an antenna array (e.g. for a MIMO compatible wireless terminal). This antenna 61 is coupled to a communication unit 62 including a receiver 621 and a transmitter 622. The communication unit 62 may be compatible with 3GPP standards, such as UMTS, LTE or NR, and operates accordingly depending on the current connection. In an embodiment, a controller 63 such as a microprocessor is included to control the communication unit and its receiver 621 and transmitter 622. It is to be noted that the controller 63 may be dedicated to the communication unit 62 and even included within it. The controller 63 may also operate other systems and not only be dedicated for the communication unit 62. Typically, some part or all of the process involved may be operating by a software stored in a memory 64 of the wireless terminal 410. However, it is also possible that the whole invention is included in hardware in the components. It is to be noted that the wireless terminal includes the functionalities to operate in accordance with a relay architecture such as Sidelink defined in 3GPP networks.

In an embodiment, the controller 63 causes the communication unit to operate in a TX-limited mode (i.e. a mode whereby the wireless terminal is not able (or prefers not) to transmit directly to the cell station and in which it may lower its transmit power, but can still receive downlink signals from the cell station). This can be done in accordance with an architecture as described with reference to FIG. 4 or in any of the further embodiments that will be detailed further herein. The controller 63 may be able to configure a receiver and a transmitter of the communication unit, and able to generate uplink data (e.g. user data, acknowledgment data, buffer status information). Depending on the current experienced conditions, or based on a particular triggering message, the controller 63 may switch to a TX-limited mode of operation.

In TX-limited mode, the receiver may be adapted to receive first downlink signals that may be sent directly by the first cell station and carrying respective first downlink control information (used here as a generic term for any control/configuration related information, not necessarily restricted to DCI related content/messages), wherein one of the respective first downlink control information includes a configuration parameter (such as a first resource indication, a transmission mode indication, or an operation mode indication, or one or more other parameters pertaining to the communication (reception or transmission)) to be used by the wireless terminal for transmitting a second signal (i.e. upstream signal/message) to the relay station and at least one of said respective first downlink control information includes at least a second allocated downlink resource to be used by the wireless terminal for receiving a further downlink signal directly from the first cell station. The configuration parameters may e.g. be a set of resources, frequencies, time/wake-up schedule, information about which modulation or signal encoding or scrambling or transmit power to use for the upstream signal/message, information about which specific types of upstream signals/messages (such as sidelink discovery messages) to use), and/or L1/L2 source or target identity information (or other identity information such as User Info ID, PRUK ID, SUCI, SUPI, GUTI, or RNTI) to use in the upstream signal/message (e.g. the identity of the relay station), or specific security credentials to be used for the upstream signal/message. The receiver may be further adapted to receive the further downlink signal directly from the first cell station on the second allocated downlink resource. Optionally, resource reservation messages and data transmission may occur in the same radio frame.

In TX-limited mode, the transmitter may be adapted to transmit to the relay station on the first resource the second signal (i.e. upstream signal/message (e.g. as in step S54 above)) carrying the uplink information and/or may use the received configuration parameter(s) to generate the upstream signal/message with the desired characteristics (e.g. with a particular transmit power, frequency, modulation format, coding scheme, protection mechanism that may be based on the battery level), said uplink information to be forwarded to the second cell station (e.g. by forwarding the received upstream signal/message and/or sending a different message containing the uplink information).

As an option for this embodiment (and that also applies to other embodiments), the controller initiates TX-limited mode operation after the receiver has received a downlink signal sent directly by the first cell station that indicates or includes a trigger to activate TX-limited mode (e.g. after the first cell station has determined e.g. through measurements that the wireless terminals uplink signals are of insufficient quality). As mentioned before, this may trigger a reduction of transmit power or different resources to be used (e.g. upstream resources directed towards the relay station instead of uplink resources for direct Uu communication with the first cell station). To this end the cell station may transmit as the downlink signal a separate TX-limited mode switch message or TX-limited mode information element as part of e.g. a SIB or RRC message or wake-up signal (i.e. a specific signal that may be received by a wake-up receiver to wake up the main radio communication module, e.g. similar to WUS as specified in 3GPP TS 36.300 and TS 36.213, or similar to IEEE 802.11ba, whereby the trigger to switch to TX limited mode may be indicated by specific timing/resource/identity used or through a wake-up signal payload), or a specific downlink signal (e.g. with a particular waveform or frequency) for this purpose. Such message/information element/signal may include an identity of the wireless terminal (e.g. L2 identity, SUCI/SUPI/GUTI, or RNTI) or an identity of a group e.g. L2 groups identity) of devices that the wireless terminal belongs to, so that the wireless terminal can determine that the message/information element/signal applies to the respective wireless terminal. The above mentioned message/information element/signal may need to be encrypted (e.g. using a pre-shared key or public key received from the first cell station (that may be signed by the core network or certificate authority or using an earlier used key or a key derived thereof (e.g. based on Kamf or Kausf or ProSe Remote User Key (PRUK))) to prevent that a malicious device can use such messages to force the wireless terminal to switch to TX-limited communication.

As another option (for this embodiment and other embodiments) the controller initiates TX-limited mode operation if the transmit or receive operation meets one or more (pre-)configured conditions (e.g. configured by the cell station through SIB/RRC messages or through UE policy information (e.g. from PCF), or pre-configured in USIM) or (pre-configured) signal strength/signal reception quality thresholds or signal transmission failure thresholds, or if the energy levels of the wireless terminal are below a certain threshold. This determination may be based e.g. on any one or more of the following methods:
a) Measurement of a signal metric of a signal received by the wireless terminal from the cell first station directly, or a signal from a relay station received at the wireless terminal, or a signal received from another cell station by the wireless terminal. For example, events like the RSRP of downlink transmissions from the cell station getting below a certain threshold may indicate to the wireless station that the wireless terminal is nearing the edge of the coverage area in which it can transmit directly to the cell station. The wireless station may need to do the measurements for a certain time interval or apply some hysteresis offset to make sure the situation is stable and to avoid a ping-pong effect. The thresholds to apply for this may be configured (beforehand) by the cell station through configuration information (e.g. as part of a SIB) sent to the wireless terminal containing the conditions/policies that the wireless terminal should apply to decide to use TX-limited mode (e.g. an RSRP threshold).
b) Detection of failed transmissions or almost-failed transmission e.g. retry counters reported from the wireless terminal directly to the cell station or vice-versa, or retry counter(s) reported from via a relay station to the wireless terminal, missing acknowledgements for messages transmitted to the first cell station. The thresholds to apply for this may be configured (beforehand) by the cell station through configuration information (e.g. as part of a SIB) sent to the wireless terminal containing the conditions/policies that the wireless terminal should apply to decide to use TX-limited mode (e.g. maximum number of failed uplink transmissions).
c) Coverage extension modes being requested by the considered wireless terminal or enabled by the network.
d) Remaining battery charge or the type of battery/power supply being used in the wireless terminal and/or whether the wireless terminal's Tx power level getting above/below a certain threshold.

Additionally or alternatively, the controller may initiate TX limited mode operation if a relay station is discovered, whereby the discovery messages received from the relay station may indicate support for TX limited operation or indicate a field (e.g. a boolean information element) that when included or has a particular value will trigger the wireless terminal to switch to TX limited mode.

As yet another option (for this embodiment and other embodiments), the transmitter is adapted to transmit an initial signal directly to the first cell station (i.e. via Uu interface) or to the relay station (i.e. via an indirect message that is to be forwarded by the relay station to the first cell station e.g. using ProSe relay procedures) that indicates or includes a trigger to activate TX-limited mode. In case of Uu interface, this may be a one-time high-power “hello” message transmission sent directly to the first cell station e.g. over an allocated UL resource or as a new or existing RACH message (e.g. with a new/additional information element indicating a request for TX limited mode) that may be sent on unscheduled resources during the Random Access procedure (see TS 38.300)), assuming that the wireless terminal has sufficient Tx power headroom and enough energy remaining still to send the “hello” message transmission. In this manner the wireless station can notify the cell station that the wireless terminal is there and it needs a relay station to transmit back (with a sustainable, lower power transmission level). Once the cell station has received such message, then it may determine which relay station the wireless terminal should use (if it has not done so yet), e.g. based on location information or measurement data or discovery information that may also be included as part of such initial signal (e.g. “hello” message), and schedule upstream resources for the wireless terminal accordingly, which it may then transmit to the wireless terminal in one of the earlier mentioned first downlink signals.

As yet another option, when the wireless terminal stops using TX-limited communication mode, a relay station may optionally continue to listen for upstream signals from pre-authorized wireless terminal(s) that are present within the pre-established security context. This is e.g. useful to detect devices that can only use TX-limited communication (and hence are unable to reach the cell station directly) at this time and that enter the vicinity of the relay station and that need to communicate. To this end, the pre-authorized wireless terminals may need to use a specific identity or credential in its discovery, ‘relay join request’ or other upstream signals/messages (e.g. PC5 signalling messages). The relay station may be configured with the corresponding information or may remember this from previous communication with the wireless terminal (e.g. uses the same or derived PC5 session key), to enable it to verify that the wireless terminal is pre-authorized. Alternatively, the relay station may forward an incoming upstream signal to the cell station to which it is connected and/or to the core network for further processing and further checking whether the wireless terminal is pre-authorized.

Since in case of TX-limited mode the wireless terminal sends the uplink information to a relay station rather than directly towards the cell station, the wireless terminal may deploy two sets of antennas (e.g. one to receive the DL signals from the cell station coming from one direction and one to transmit upstream signals to a relay station into another direction) or a single set of antennas that may switch intermittently between a mode for receiving DL signals from the cell station and a mode for transmitting upstream signals to a relay station. To this end, the wireless terminal may be configured by the cell station with (estimated) location information (e.g. geographical coordinates or relative coordinates or distances/directions from a reference point) of the cell station, wireless terminal and/or relay station, and/or direction information (e.g. angle between incoming DL signal from the cell station and outgoing upstream signal to the relay station, angle of departure relative to a reference line or the magnetic north of the DL signal or the upstream signal). This allows the wireless terminal to configure the antennas accordingly and receive/send the signals from/to the correct direction (e.g. by changing the beamforming characteristics of the transmitted signals). This enables beamforming into the direction of a relay station (which may be a different beam or have different Synchronization Signal Block (SSB) index than a beam directed to the first cell station. The wireless terminal may also be configured by the cell station with information about the timing of the mode switching (e.g. based on regular intervals, or in relation to the scheduled resources for downlink and upstream communication). This is useful in case of switching the antennas between a mode for receiving DL signals from the cell station and a mode for transmitting upstream signals to a relay station. Alternatively, the wireless terminal may deploy one or more omnidirectional antennas, in which case the location/angle may not be necessary and may be ignored. However, in case of a single omnidirectional antenna mode switching may be applied and the wireless terminal may be configured accordingly with information about the timing of the mode switching.

In other words, as an option, the receiver and transmitter may each operate a different set of antennas, and the controller may instruct the transmitter to perform beamforming into the direction of a relay station, e.g. based on location of the relay station and/or angle information (e.g. angle between a beam used for a downlink signal from the cell station as received by the wireless terminal, and the beam used for an upstream signal directed towards a relay station). Such position information or angle information may be received from the first cell station and/or the relay station.

In an embodiment, the controller 63 causes the communication unit to operate alternatively in accordance with the network with a conventional architecture and the network with a special architecture described with reference to FIG. 4 or in any of the further embodiments that will be detailed further hereinafter. Depending on the current experienced conditions, or based on a particular triggering message, the controller 63 switches the conventional operation (e.g. direct bidirectional operation with the cell station acting as a scheduler) to the asymmetric operation (i.e. TX-limited mode of operation). In this case, the controller 63 can configure the receiver to receive and decode a resource reservation message indicating an upcoming downlink message (e.g. a paging message) from the cell station, and to receive the downlink data transmission on the scheduled radio resources from the cell station. Optionally, the resource reservation messages and the data transmission may occur in the same radio frame.

Furthermore, the controller 63 may be adapted to request radio resources for data transmission by causing the transmitter 622 to send a message to at least one relay station 420.

Furthermore, as explained in link to the flowchart of FIG. 5, the reservation message coding, contents and/or timing can indicate to the wireless terminal 410 the Ds-resources for downlink data reception and the Us-resources allocated for transmission, optionally in a single message.

The transmitter 622 can be configured to send data that is intended for the cell station, to the relay station over the reserved upstream resources. The contained data may include for example, feedback data e.g. ACK/NACK indicating whether or not the wireless terminal 410 has successfully received the data transmission from the cell station, new user data destined to the network or an edge server located at the first cell station, or other control messages such as Buffer Status Report (BSR) data which indicates the status of one or more of the transmission buffers of the wireless terminal 410.

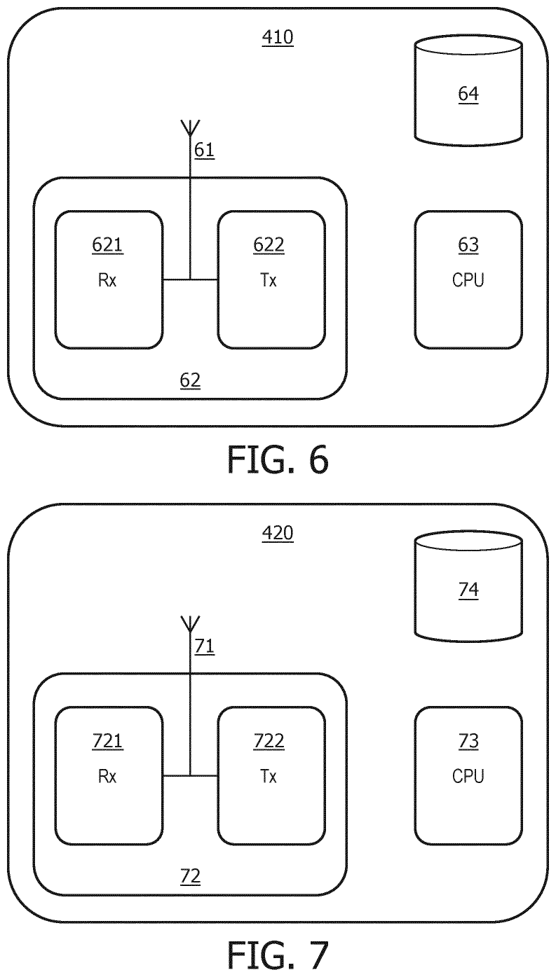

As shown on FIG. 7, the relay station 420 which can operate as a Relay UE typically includes an antenna 71 or an antenna array (e.g. for a MIMO compatible wireless terminal). This antenna 71 is coupled to a communication unit 72 including a receiver 721 and transmitter 722. The communication unit 72 may be compatible with 3GPP standards in these exemplary embodiments, such as UMTS, LTE or NR, and operates accordingly depending on the current connection. In an embodiment, a controller 73 such as a microprocessor is included to control the communication unit 72 and its receiver 721 and transmitter 722. It is to be noted that the controller 73 may be dedicated to the communication unit 72 and even included within it. The controller 73 may also operate other systems and not only be dedicated for the communication unit 72. Typically, some part or all of the process involved may be operating by a software stored in a memory 74 of the relay station 420. However, it is also possible that the whole invention is included in hardware in the components. It is to be noted that the relay station includes the functionalities to operate in accordance with relaying operation such as Sidelink transmission and reception as a Relay UE in 3GPP networks.

In the present embodiment, the relay station is either directly or indirectly connected to the network, e.g. the Core Network (CN) via a cell station, e.g. a RAN base station. The receiver 721 is configured by the controller 73 to receive and decode an upstream assignment sent by the cell station and indicative of resources to be used for an incoming upstream transmission from the wireless terminal 410. This scheduling assignment includes reservation coding, contents, frequency information and/or timing information, indicating implicitly or explicitly (e.g. by an identifier) the resource reservation to be used by the wireless terminal 410 directly connected to the relay station via a radio link. Optionally, an identifier of the wireless terminal 410 (e.g. an L1 or L2 identifier) is included in the scheduling assignment to indicate the wireless terminal 410. The controller 73 is adapted to configure the receiver to then receive data from the wireless terminal 410 on the scheduled resources as mentioned at step S55.

The controller 73, in accordance to relay operation, is adapted to control the receiver 721 and the transmitter 722 for relaying upstream data from the wireless terminal 410 to the cell station 400. This forwarding transmission may be direct or indirect through an upstream parent node.

Further, the relay station may be adapted to send feedback data (e.g. ACK/NACK) to the wireless terminal 410 in response to receiving data from it, indicating whether or not the data was correctly received.

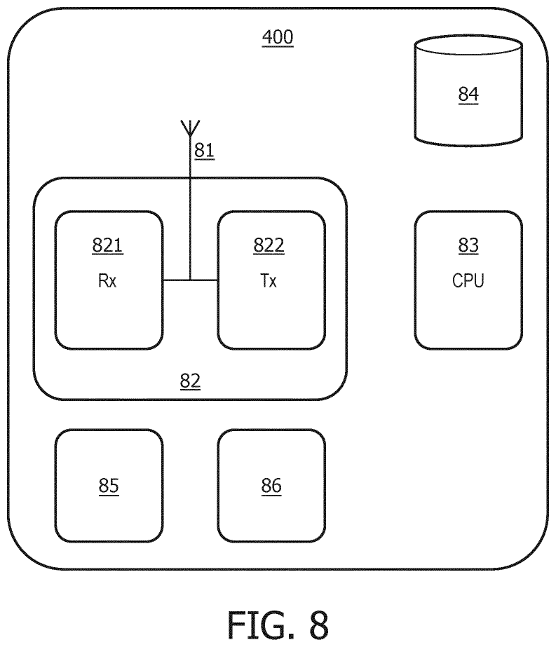

As shown on FIG. 8, the cell station 400 includes an antenna 81 or an antenna array (e.g. for a MIMO compatible cell station). This antenna is coupled to a communication unit 82 including a receiver 821 and a transmitter 822. The communication unit 82 may be compatible with 3GPP standards in these exemplary embodiments, such as UMTS, LTE or NR, and operates accordingly depending on the current connection. In an embodiment, a controller 83 such as a microprocessor is included to control the communication unit 82 and its receiver 821 and transmitter 822. It is to be noted that the controller 83 may be dedicated to the communication unit 82 and even included within it. The controller 83 may also operate other systems and not only be dedicated for the communication unit 82. Typically, some part or all of the process involved may be operating by a software stored in a memory 84 of the cell station 400. However, it is also possible that the whole invention is included in hardware in the components. Furthermore, the cell station 400 includes a scheduler 85 coupled to the controller 83 which takes care of assigning the shared resources of a cell to a plurality of secondary stations. An interface 86 is included for managing the communications with the Core Network. The interface 86 may also be adapted to managing communications with other cell stations over different interface (e.g. X2) using backhaul channels.

As explained in relation to FIG. 5, the controller 83 of the cell station 400 is adapted to configure the transmitter 822 to transmit downlink data to the wireless terminal 410. The controller can operate without receiving any transmission e.g. feedback from said wireless terminal 410 (at least not directly). Further, the receiver 821 is adapted to receive and process feedback data indicating whether or not previous DL transmitted data to the wireless terminal 410 was correctly received or not; the feedback data being received from the wireless terminal 410 directly or indirectly, i.e. via the relay station 420.

Further, the scheduler is adapted to schedule resources to allow the special asymmetric operation described in FIG. 5. This may include the schedule of downlink data for the downlink transmission directly from the cell station 400 to the wireless terminal 410. This also may include the allocation of upstream resources between the wireless terminal 410 and the relay station 420. The corresponding resources (for receiving the upstream signals/uplink information from wireless terminal 410) may also be signalled to the relay station to indicate an incoming upstream transmission from the wireless terminal. Eventually, in this particular example where the relay station is located in the cell served by the cell station, the scheduler can also schedule the resources to be used by the relay station for forwarding the incoming upstream data.

The scheduling operation may be based at least partly on information regarding the buffer status of the various stations in the network, including the relay station 420 and possibly the wireless terminal 410. The BSRs can be received directly or indirectly from the wireless terminal 410.

Similar to the wireless terminal 410 and the relay station 420, the controller 83 may be able to switch for a considered station between a ‘normal’ operation mode (direct bidirectional connection), to a ‘relayed’ mode (indirect bidirectional connection (all communication upstream and downstream going through one or more relay stations)) and/or ‘Tx-limited’ mode (indirect connection with direct DL data transfer and scheduling). This connection mode may be selected depending on the considered UE capabilities, i.e. if that UE supports these modes.

As a result of this embodiment, the wireless terminal acting as a Remote UE can reduce the number of times it needs to “sense” Sidelink channels to self-schedule the resources to transmit on
in many cases it can simply await the cell station (gNB) scheduling decision for Us-resources and send on those Us-resources. Thus, this reduces the energy consumption for the wireless terminal.

Also, the cell station or gNB can schedule communication resources more optimally using the knowledge/data/measurement-reports of many UEs, and knowledge/data/measurement-reports of many more communication resources/channels/bands. Hence, it is able to evaluate better the load of each Relay station and decide in a smarter way for the scheduling and/or the switch of a considered UE into this asymmetric mode of operation.

It is to be noted that, in some situations self-scheduling by the wireless terminals may remain necessary, for example if the cell station has not allocated any resources to a wireless terminal and the latter needs to indicate indirectly to the network that it has pending data for transmission, for example by transmission of a BSR and/or by transmission of user data (e.g. urgent user data, such as for emergency services) to the relay station.

Besides, in the “Tx-limited” mode, the downlink data capacity may be higher as in the “relayed” mode since the data can be directly sent from the cell station to the wireless terminal acting as a Remote UE, without requiring an indirect path via a relay station as would be usually the case with relayed data. As a result, the data from the cell station to the wireless terminal does not “burden” the Sidelink (SL) resources available between the relay station and its wireless terminals. In an implementation where the network or the relay station defines how the Sidelink resources are shared between upstream data and downstream data, it is possible to reduce the share of downstream Sidelink resource to the benefit of upstream Sidelink resource for example. This leaves also more Sidelink resources available for other types of Sidelink communication (e.g. D2D, V2X, ProSe, relaying).

For the relay station, it is also advantageous not to have to sense all the potential SL channels where a wireless terminal acting as a Remote UE could transmit, all the time. Instead, the relay station can instead listen specifically on the scheduled channels i.e. resources Us-Rx to receive a wireless terminal transmission. As a consequence, the relay station could use a more advanced “energy saving” mode (e.g. DRX energy saving modes) as present in 3GPP without having to be “always-on” listening for Sidelink resources where a wireless terminal might potentially send data to the relay station.

Some more details regarding the resource scheduling as envisaged in 5G is provided in the following. The resource scheduling in 5G consists of an intricate interplay of multiple scheduling mechanisms and protocols, that work alongside each other.

The main method of scheduling in 5G is dynamic, which means resources are allocated on demand based on available data and channel conditions. There is also semi-persistent scheduling (SPS), which is a preset schedule that can be quickly activated/deactivated by a gNB, based on present demand. Finally there is a persistent schedule that can be activated once and stays active until explicitly cleared by certain specified events. The idea is that dynamic scheduling decisions are always added on top of the persistent/semi-persistent ones, to cope with variation in data rate or special occurrences such as a data retransmission. For the scheduler to learn about channel conditions, a complex ensemble of reporting structures is defined in 3GPP to report measurements to gNB; together with control mechanisms for gNB to enable/disable/request reports on the fly.

The protocols used in implementing the scheduling mechanisms are various:
RRC, see also FIG. 2B. This can operate end-to-end between a gNB and a UE in UL and DL, potentially over one or more relay hops over SL when using the new L2 relay architecture. It is mostly used for non-time-critical, static or semi-static schedule information. In other words, the configuration of schedules. ConfiguredGrantConfig is the information element for uplink scheduling.
MAC Control Elements (CE)—these are short elements (a.k.a. Information Elements or IEs) inserted in between existing UL/DL/SL transmissions over the MAC layer, used to efficiently signal certain events or configurations in UL, DL or SL. One specific case is the Buffer Status Report (BSR) MAC CE that is used by UEs to signal their current data buffer status towards gNB/scheduler. It is the main mechanism for a UE to indicate it has data pending that needs UL scheduling. When a UE has some data available for transmission in its buffers, and an UL grant for resources, it uses a part of this resource to add an information about one or more of its buffers for one or more corresponding Logical Channel Groups. When however there is no UL grant for resources, the other mechanism for requesting resources is the Scheduling Request (SR) in UCI. Other MAC CEs are used by gNB to control the UE's behavior in executing the above-mentioned measurements and DRX.
Downlink Control Information (DCI)—a short message sent in downlink in a low-bitrate control channel (PDCCH) with special blindly-detectable modulation/coding. It is at PHY L1 layer and does not use the MAC L2 header structure. Various DCI formats are defined with different information content. Resources for dynamic scheduling are indicated in the DCI; usually a DL data transmission follows the DCI message within less than 1 ms but can be scheduled for up to 4 ms ahead. For UL, the scheduling is usually made for a next slot 1-2 ms ahead, but can be up to 8 ms ahead. For scheduling of Sidelink resources, DCI Format 3_0 and Format 3_1 are defined in TS38.212. These are only SL resources to be used by the scheduled UE itself for transmission, not to be used by a Remote UE for transmitting to the Relay UE.

Note that in this document, the term downlink control information is used as a generic term for any control/configuration related information, not necessarily restricted to DCI related content/messages, but may e.g. also be sent as part of a System Information Block (SIB), RRC or MAC CE message.
Uplink Control Information (UCI)—a short byte sequence sent uplink in PUCCH using one of a few different formats. The UCI includes Scheduling Request (SR) bit; used by the UE when there are no UL resources to transmit BSR MAC CE in. In response to SR, the gNB scheduler will allocate UL resources for the UE in the future.

Of the above, only the RRC protocol messages can be carried end-to-end between a Remote UE and gNB in case of an L2 relaying architecture—see FIG. 3. All the other mechanisms need to work directly between gNB and a UE in direct radio contact at L1/L2, or, if defined, between a Relay UE and its downstream Remote UE.

The above resource scheduling overview is applicable for UEs directly connected to gNB. If single- or multi-hop relays are introduced into a network, then these solutions are not sufficient because they operate mostly on a direct link between gNB and UE. There are various solution directions already known or discussed in 3GPP RAN Working Groups how such scheduling could work in a single-hop relaying situation. For example
OoC Remote UEs could self-schedule their transmissions on SL based on own channel measurements and a random-access process. This is called “resource allocation mode 2” in TR37.985.
gNB can schedule resources for all directly connected Relay UEs as defined in TR37.985 “resource allocation mode 1” to transmit to a Remote UE. However, there's no mechanism for gNB to schedule for reverse traffic back to the Relay UE.
gNB schedules all resources for all directly and indirectly connected UEs (note: details of such method are not yet defined by 3GPP).
one leading UE of a group could coordinate resource assignment to its group members, which could even work if some group members would be out-of-coverage but still in range of the leading group member UE.

It is important to note that one recently mentioned issue in 3GPP RAN #86 meeting discussions on Release 17 scope is that self-scheduling for Sidelink (SL), as currently defined for V2X communications, is not energy-efficient and therefore deemed unsuitable for small, battery-powered devices like mobile phones or IoT devices. The main V2X use case for this communication has been so far V2V (vehicle to vehicle) communications where energy consumption is not a major issue.

In variants of the previous embodiments, the wireless terminal can be connected as a Remote UE. In this role, it can detect that it is able to receive one or more cell stations' signals. Upon this determination, the wireless terminal may send a message to its relay station (e.g. a Relay UE) indicating the cell stations signals (and/or identities of the cell stations) it is able to receive. It may include an indication of energy or power level or signal quality that would help in the decision to switch to the asymmetric operation mode). The relay station then sends or relays this information further to its own upstream cell station. Optionally this information may be further disseminated in the RAN, so that RAN configures at least one cell station (preferably corresponding to the one detected initially by the wireless terminal) for direct transmissions of data and/or resource reservations as described in the previous embodiments or as will be detailed in further embodiments.

Besides, when a wireless terminal is connected as a Remote UE and in Tx-limited state; the cell station can be configured to monitor and detect a change of the Tx-limited state to a regular state that allows two-way communication with the wireless terminal. This can be done for example by the cell station detecting transmission from the wireless terminal taking place in allocated Us-resources to the relay station. Other suitable methods (monitor of RSSI, signal quality monitoring based on Reference Signals, or other) may be used. In response, the cell station notifies the wireless terminal to trigger a switch from Tx-limited operation to regular operation.

When the wireless terminal is connected as a Remote UE and in Tx-limited state; then the wireless terminal may detect as well a change of the Tx-limited state to an out-of-gNB-coverage state in which no communication to or from the gNB is possible anymore. This could be monitored by detecting that no gNB transmissions are received anymore, such as synchronization signals or the periodically broadcasted system information (SIBs). Alternatively, some conventional monitoring of the Received Power or Quality may be used in this context (similar to measurements performed for the purpose of a handover). In response, the wireless terminal switches from Tx-limited operation to regular Relay operation as a Remote UE. The wireless terminal may also notify the cell station gNB about this new situation (via an indirect message forwarded by Relay UE).

In an embodiment, let's take the case of the wireless terminal 410 being connected as a Remote UE and in transmission-limited state. When the relay station 420 detects that it goes out of the cell station 400 coverage, so that no relay communication to or from the cell station is possible anymore, then the relay station 420 stops its relay operation for the wireless terminal 410, and it notifies the wireless terminal 410 via a Sidelink message. The wireless terminal 410 then starts a discovery process to look for a new relay station to use. In the meantime, the wireless terminal 410 may also check if it can re-enter in a normal operation with direct bidirectional operation with the cell station. In order for the relay station 420 to detect that it goes out of coverage, it can for example detect that no gNB transmissions are received anymore such as the periodically broadcasted system information (SIBs). In another example, the relay station can use one of the Measurement events such as detecting that the RSRP/RSRQ from the cell station is lower than a threshold. These events would be the sign that the relay station is moving out of the cell or that its connection quality is degrading. Another possibility could be the relay station noticing a substantial change of location, for example based on GPS coordinates.

In a further embodiment, a cell station (noted gNBx) may send out a specific “discovery” type signal indicating to all the wireless terminals acting as Remote UEs and/or that are in transmission-limited state, so that they should respond to the signal if they are able to receive it. After receiving such a signal, such a wireless terminal operating in a full relay operation can respond by sending a discovery request or response to its own relay station 420 (e.g. using ProSe/sidelink discovery messages) or another nearby relay station 420. The relay station 420 then forwards the discovery response to its own cell station gNB1 and/or to the Core Network, CN, and/or to the cell station gNBx that originated the “discovery” signal, for example if it is part of its Active Set (the base stations in which the relay station 420 is currently in contact with) via RAN. After receiving the discovery response, one entity in RAN (e.g. gNBx) configures direct transmissions of data/resource reservations to the considered wireless terminal as described in the embodiments of this invention (e.g. to enable the asymmetric operation mode).

In these various examples, a cell station gNBx can determine that a considered wireless terminal is in TX-limited state and/or the network (e.g. NG-RAN) can determine that the considered wireless terminal is in TX-limited state and can then instruct one or more cell stations to use TX-limited operation with the considered wireless terminal. This determination can be based on any one or more of the following methods:
a) Measurement of a signal metric of a signal received by the cell station from the considered wireless terminal directly, or a signal from the wireless terminal received at a relay station, or a signal from a relay station near the wireless terminal, or a signal from a relay station serving the wireless terminal, or a signal from the wireless terminal received by another cell station. For example, events like the RSRP of uplink transmissions from the wireless terminal getting below a certain threshold indicates to the cell station that the wireless terminal is nearing the edge of the coverage area in which it can transmit directly to the cell station. The cell station may need to do the measurements for a certain time interval or apply some hysteresis offset to make sure the situation is stable and to avoid a ping-pong effect.
b) Detection of failed transmissions or almost-failed transmission e.g. retry counters reported from the wireless terminal directly to the cell station, or retry counter(s) reported from the wireless terminal via a relay station to the cell station, missing acknowledgements for messages transmitted to the wireless terminal, or the wireless terminal's Tx power level getting above a certain threshold which is subsequently reported to the cell station directly.
c) Coverage extension modes being requested by the considered wireless terminal or enabled by the network.
d) Historical data or analytics data showing that the wireless terminal is experiencing uplink issues.
e) Capability information and/or state information (e.g. denoting a TX limited capability and/or state) and/or identity information (e.g. a device belonging to certain group of TX limited devices) of the considered wireless terminal, received from the considered wireless terminal (e.g. through RRC, MAC CE or initial RACH messages or Registration/Attach messages), from application function, or from the Unified Data Management (UDM) network function (e.g. part of subscription information) or received through the Network Exposure Function (NEF). This may include knowledge about the device model, the number of antennas, UE category, whether it supports RF backscatter communication etc.
f) Remaining battery charge or the type of battery/power supply being used in the wireless terminal. This may also include information about whether the device may not have a battery and/or may only obtain energy from energy harvesting. This information may be reported for example while the wireless terminal still has a bidirectional link with the cell station or through an initial RACH messages or Registration/Attach messages.

In a further variant of the previous embodiments, once a cell station has determined, for example based on one of the above discussed mechanisms that a considered wireless terminal is in Tx-limited state, a cell station may send a message to a relay station (preferably the relay station in communication with the considered wireless terminal) possibly indicating the identity of the wireless terminal, and indicating it will use Tx-limited communication mode. The indicated identity of the considered wireless terminal may be used in future resource scheduling messages from the cell station, such that the relay station can infer from the resource scheduling message that it is intended for the wireless terminal transmitting upstream data to the relay station. It is also possible that the relay station is informed of an incoming uplink message on some of the uplink/upstream resources. As an example, the identity is an RNTI (Radio Network Temporary Identifier) of the wireless terminal. The relay station may use this RNTI in addition to its own RNTI for monitoring the PDCCH messages in order to receive DCIs from the cell station relative to the wireless terminal and using the DCI to be able to receive the upstream information from the wireless terminal using the allocated uplink/upstream resources.

Alternatively, the cell station may signal a set of Us-Rx-resources (e.g. a resource pool) that are to be monitored by the relay station (instead of a specific resource relative to a single transmission). The actual resources allocated to the wireless terminal may only be one or more resource blocks from the set of Us-Rx-resources signaled by the cell station to the relay station. As in the above example, an identity of one or more wireless terminals expected to transmit may optionally be signaled. The set of Us-Rx-resources may also be signaled as a semi-persistent schedule, time/wake-up schedule or as a particular frequency to monitor.

In a further variant of the invention, the wireless terminal can connect to a relay station using a 3GPP 5G ProSe relay discovery and selection procedure.

In still another variant of the previous embodiments, a wireless terminal can report any position change in a position change status report indirectly (via the Relay station) to the cell station. If there is little or no position change, the cell station can maintain the same operation mode with respect to the wireless terminal (e.g. full Relay operation or Tx-limited mode or direct bi-directional mode). If there is a substantial position change, the cell station can adapt its transmission settings towards the wireless terminal and/or cause a different cell station to take over its role as direct cell station. Another possibility is the cell station to start some measurements or configure the wireless terminal to perform some measurements to detect if another cell station is more suitable or if another mode of operation would be more suited to the current conditions. The measurements performed at the wireless terminal could be similar to the measurements performed for the cell station handover mechanism.

In yet another variant of the previous embodiments, the cell station can configure and activate a Discontinuous Reception (DRX) mode in the wireless terminal by a direct message and then the wireless terminal can transmit to its relay station during its “wake” time. The DRX mode enables a terminal to intermittently switch off its communication unit, thereby reducing its energy consumption and to become active during some periodic wake periods. As the cell station is aware of the periodicity of the DRX burst pattern, it can adapt the resource scheduling accordingly. Similarly, the cell station can activate DRX in the relay station and then schedule resources for transmission from the wireless terminal to its relay station only during the wake periods of both the wireless terminal and the relay station.

It is to be noted that all the previously described embodiments may be combined with one or the other. Besides, unless explicitly indicated, these variants are equally applicable to the other embodiments of the invention.

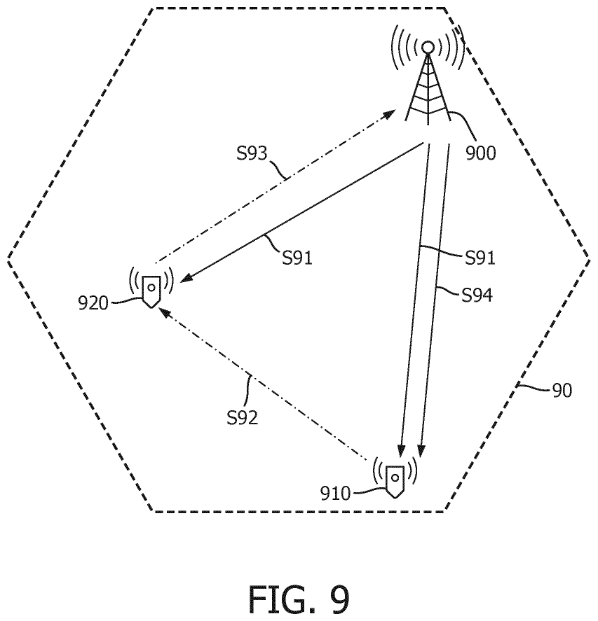

In accordance with a second embodiment of the invention, the operation of the system will be now described with reference to FIG. 9. In this system, a wireless terminal 910 is under the coverage of the cell station 900, i.e. cell 90. A relay station 920 also connected to the cell station 900 can act as a relay between the wireless terminal 910 and the cell station 900. In normal operation, the wireless terminal can receive data and control signalling from the cell station 900 directly and transmits data and control information back to the cell station on a direct link. If the wireless terminal 910 is completely disconnected from the cell station 900, for example when it cannot receive correctly the signals originating from the cell station 900, the wireless terminal 910 can enter into a full Relay operation thanks to the relay station 920. In this operation mode, all upstream and downstream connections go through the relay station 920. However, as explained in the past embodiments, the wireless terminal 910 can also operate in a Tx-limited operation when it is in a Tx-limited state.

In this specific case, the wireless terminal 910 can generate upstream user data that is sent via a relay station 920. The data may then optionally be acknowledged by the cell station 900 via a direct transmission. The detailed operation may be performed as described below:
As an initial step S90 (not shown), optionally the wireless terminal 910 may indicate to a Relay station 920 that it has pending data to be transmitted. This can be done, for example through a Buffer Status Report (BSR) type message, or a Scheduling Request type message followed by a BSR, e.g. using pre-configured Sidelink resources for this purpose. This step is optional in particular if the cell station has already Us-resources scheduled for the wireless terminal 910 and corresponding resources Us-Rx for the relay station 920 (to use for receiving the incoming upstream data) to use in the near future based e.g. on a previously received BSR or SR+BSR by the cell station. After the wireless terminal 910 sends this indication e.g. a Buffer Status Report type message to the relay station 920, the relay station 920 may indicate to the cell station that the wireless terminal needs resources. This can be done simply by forwarding the corresponding BSR or by some other signalling. The wireless terminal may for example send additional information to the relay station that is to be sent further to the cell station 900, e.g. a measurement report or other message indicating that the wireless terminal 910 is currently a Tx-limited station, i.e. it can receive the data directly from the cell station 900, but cannot successfully send data to the cell station 900. It may also send a request for moving to TX-limited operation (e.g. due to limited remaining battery capacity or other events as mentioned in earlier examples). Also, some user data may be sent interleaved with the SR/BSR and previously mentioned messages to the relay station 920. Upon receiving information via the relay station that the wireless terminal 910 needs resources or operates/supports a TX-limited mode, the cell station 900 may schedule the upstream resources for wireless terminal 910 and may also schedule the corresponding resources for relay station 920 to receive the upstream signals from wireless terminals 910 and send the scheduled resources as part of the first or second downlink signals. Alternatively, even though the wireless terminal 910 may be TX limited, it may be able to send a specific signal (e.g. narrowband pulse, or Scheduling Request, or a signal on a particular frequency and/or lower frequency than it would use for normal operation, or a signal that is temporarily sent with a higher transmit power than the device could sustain for longer period of time) that may be received by the cell station 900 (or a nearby other cell station) and that may indicate that the wireless terminal needs resources or operates/supports a TX-limited mode. If such signal is received by the cell station 900, the cell station 900 may schedule the upstream resources for wireless terminal 910 and may also schedule the corresponding resources for relay station 920 to receive the upstream signals from wireless terminals 910 and send the scheduled resources as part of the first or second downlink signals.
In step S91, the cell station 900 (gNB1) may transmit one single control message including allocation of resources or a set of control messages that may indicate a set of resources, frequencies and/or time/wake up schedule related information. This control message may include an identifier of the wireless terminal 910 or an identifier common to the couple “wireless terminal 910—relay station 920”. This message may indicate Us-resources or e.g. a particular frequency for use by the wireless terminal for doing a future data transmission and/or the corresponding indication of an assignment of resources (for use by the relay station) corresponding to the Us-resources and indicative of the incoming upstream data from the wireless terminal 910. In an example, the indication of the allocated Us-resources and the assigned Us-Rx-resources for the incoming upstream is described by a single field or by a single array of bytes of the control message. As another example of an indication of allocated Us-resources, the control message from the cell station 900 (gNB1) may include a flag or parameter to indicate to the wireless terminal 910 to use (a subset of) sidelink resources that may already have been configured in the wireless terminal 910. The control message may also contain additional information on how the upstream signals are to be transmitted by the wireless terminal 910 (e.g. which modulation or signal encoding or scrambling or transmit power to use, which specific types of signals/messages (such as sidelink discovery messages) to use/generate), and/or which L1/L2 source or target identity information (or other identity information such as User Info ID, PRUK ID, SUCI, SUPI, GUTI, or RNTI) to be used in the messages (e.g. the identity of the relay station), or specific security credentials to be used for the messages. The wireless terminal 910 may use this information to generate the respective upstream signals to be received by the relay station 920. Similarly, the relay station 920 may receive corresponding information from the cell station 900 and use this information to receive the specific upstream signals from the wireless terminal 910.

It is to be noted that the wireless terminal 910 and the relay station 920 may have been preconfigured to monitor the control region for the corresponding DCI type and based on an identifier. As mentioned earlier, the identifier can be a newly defined “Remote-UE-RNTI” linked to the wireless terminal 910, or an identifier created for the couple of “wireless terminal 910—relay station 920”. Thus, this would allow the cell station to schedule resources for the wireless terminal with different respective relay stations. This would alleviate the risk of a relay station to completely disrupt the upstream connection of the wireless terminal if it moves away as a fallback relay station could be used easily by allocating resources with a different RNTI. When monitoring the control region, each of the wireless terminal 910 and the relay station then blindly decodes a set of PDCCH candidates based on the RNTI to detect if a valid DCI is included.

Thus, in Step S91, both the wireless terminal 910 and the relay station 920 receive and decode the PDCCH message with a CRC scrambled with this new RNTI type from the cell station 900. As a consequence, this causes the relay station 920 to attempt to ‘descramble’ the PDCCH message with both its own identity (typically its C-RNTI) and the new RNTI to determine for what and whom the message is intended. Once the PDCCH decoding is successful, the corresponding DCI allows for the configuration of:
The wireless terminal 910 transmitter to prepare and transmit a data transmission using the allocated Us-resources; and
The relay station 920 receiver to listen (Rx) for a data transmission using the same Us-resources.
   In step S92, the wireless terminal 910 transmits data in the scheduled resources and the relay station 920 listens to the transmitted data in the same/corresponding resources. Typically, the cell station 900 may not be able to receive the transmitted data correctly due to the transmission limitations on the wireless terminal as indicated earlier.
   In step S93, the relay station 920 relays the received data from the wireless terminal upstream towards the cell station 900. It is to be noted that this relay may be directly or indirectly connected over multiple hops. For the sake of simplicity, only the direct relay is shown in FIG. 9. The relay station 920 may use uplink resources allocated concomitantly with the resources allocated in step S91 in a separate PDCCH message, with a CRC this time scrambled with the relay station 920 RNTI. It is also possible that a Semi-Persistent Scheduling resource is allocated to the relay station to allow it to forward the data transmissions from all its Sidelink connected terminals. Still another possibility is that the message sent at step S91 includes a further allocation of resources to be used by the relay station for the forwarding. This further allocation of resources would need to be signalled earlier than usual allocations to allow the relay station to process the incoming upstream and prepare the data packet to be forwarded.
   In step S94, the cell station 900 optionally sends feedback data directly to the wireless terminal 910 to e.g. acknowledge (ACK/NACK) the reception of upstream data from the relay station 920. This may be a HARQ acknowledgement data, PDCP feedback data (or higher layer (e.g. IP), or other) using PDCP Control PDU, PDCP status report PDU type, containing FMC and bitmap data as specified per TS38.323. Besides, the cell station 900 could also (or alternatively) transmit this feedback data through the relay station to the wireless terminal (thus indirectly). It is however assumed that that a direct transmission is more efficient. The feedback data may be optionally combined with further downlink data to the wireless terminal, for efficiency, in the same transport block.

It is to be noted that each transmission hop of the indirect network connection may include e.g. a corresponding MAC HARQ process such that each hop is acknowledged at the MAC level.

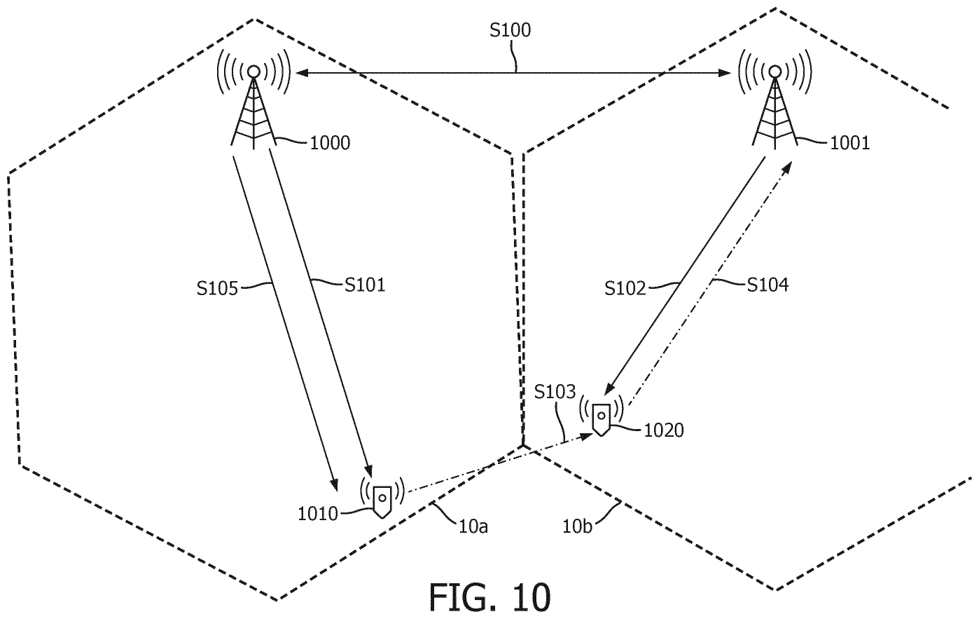

The third embodiment depicted on FIG. 10 corresponds to the second embodiment except that the relay station 1020 is now served by a cell station 1001 (in cell 10b) different from the cell station 1000 serving the wireless terminal 1010 (in cell 10a). Thus, it will now be described this specific case where the wireless terminal 1010 generates upstream user data, which is acknowledged by the cell station 1001. As explained, there are two cell stations, cell station 1001 used by the relay station 1020 and cell station 1000 which the is the cell station that can transmit directly to the wireless terminal 1010. So, the cell station 1000 can transmit the upstream resource allocation to the wireless terminal 1010 and the cell station 1001 can transmit the corresponding upstream resource assignment to the relay station 1020.
As a preliminary step not shown, the wireless terminal 1010 may initiate/trigger a resource reservation if needed as done in step S90 of the previous embodiment.
In step S100, the two cell stations 1000 and 1001 coordinate their next transmission in time i.e. the Us-resources to use for transmission for the wireless terminal 1010 and the Us-Rx-resources to listen for the Relay station 1020. In this case, the Us-resources may be identical to or may have substantial overlap with the Us-Rx-resources (i.e. the Us-resources are included in the signaled Us-Rx-resources which can e.g. be signaled through Semi-Persistent Scheduling (SPS), dynamic scheduling, or as a pool of resources).
In step S101 and step S102, the cell stations 1000 and 1001 respectively transmit a communication resource reservation message that indicates radio Us-resources and Us-Rx-resources respectively for use by one or more of the wireless terminals 1010 for doing a future data transmission and by the relay station 1020 for doing the data reception. It is to be noted that the Us-Rx-resources may be signaled earlier, for example as part of a Relay configuration Information Element indicating a pool of resources, or an SPS allocation. In that case, this could be done earlier than step S100. This is not specific to this embodiment and could also apply to the other described embodiments. Both the wireless terminals 1010 and the relay station 1020 may receive the reservation via their respective cell stations and decode the PDCCH message by detecting or descrambling the message by means of an identifier. This identifier may be the “Remote-UE-RNTI” mentioned in the previous embodiment for both. Alternatively, it may be the “Remote-UE-RNTI” to be used by the relay station for descrambling PDCCH candidates and a regular RNTI to be used by the wireless terminal for descrambling PDCCH candidates. The relay station then configures its receiver to listen (Rx) for a data transmission using the Us-Rx-resources; Alternatively or additionally, the cell stations 1000 and 1001 may exchange information with each other and/or may transmit a set of control messages to wireless terminal 1010 that may indicate a set of resources, frequencies and/or time/wake up schedule related information, or may include additional information on how the upstream signals are to be transmitted by the wireless terminal 1010 (e.g. which modulation or signal encoding or scrambling or transmit power to use, which specific types of signals/messages (such as sidelink discovery messages) to use/generate), and/or which L1/L2 source or target identity information (or other identity information such as User Info ID, PRUK ID, SUCI, SUPI, GUTI, or RNTI) to be used in the messages (e.g. the identity of the relay station), or specific security credentials to be used for the messages. The wireless terminal 1010 may use this information to generate the respective upstream signals to be received by the relay station 1020. Similarly, the relay station 1020 may receive corresponding information from the cell station 1000 or 1001 and use this information to receive the specific upstream signals from the wireless terminal 1010.
In step S103, the wireless terminal 1010 transmits upstream information in the scheduled Us-resources, and the relay station 1020 receives the upstream information in Us-Rx-resources.

Typically, the cell station 1000 may not be able to receive the transmitted data correctly due to the transmission limitations on the wireless terminal as indicated earlier. And the cell station 1001 is out of range for the wireless terminal, possibly and/or the wireless terminal 1010 has no active connection to the cell station 1001 to transmit to it directly.
In step S104, the relay station 1020 relays the received upstream information e.g. user data, from the wireless terminal 1010 upstream towards its cell station 1001. The cell station 1001 optionally notifies the cell station 1000 about what feedback data to be sent back to the wireless terminal 1010 from the cell station 1000.

It is to be noted that this relaying may be direct or indirect over multiple hops. For the sake of simplicity, only the direct relaying is shown in FIG. 10. The relay station 1020 may use uplink resources allocated concomitantly with the resources allocated in step S101 in a separate PDCCH message, this time with its CRC scrambled with the relay station 1020 RNTI. It is also possible that a Semi-Persistent Scheduling resource is allocated to the relay station, possibly even before step S100, to allow it to forward the data transmission from all its Sidelink connected terminals. Still another possibility as mentioned in the previous embodiment is that the message sent at step S101 includes a further allocation of resources to be used by the relay station 1020 for the forwarding. This further allocation of resources would need to be signalled earlier than usual allocations to allow the relay station 1020 to process the incoming upstream and prepare the data packet to be forwarded.
In step S105, the cell station 1000 optionally sends feedback e.g. acknowledgements to the wireless terminal indicating whether the data was correctly received as in the previous embodiment.
These may be HARQ or PDCP level acknowledgements as detailed in the previous embodiment, or higher layer (e.g. IP), or other. The feedback data in steps 104 and 105 are marked optional because these may also be sent via the relay station 1020 to the wireless terminal 1010 instead of via the cell station 1000, depending on the decision of scheduler in cell station 1001.

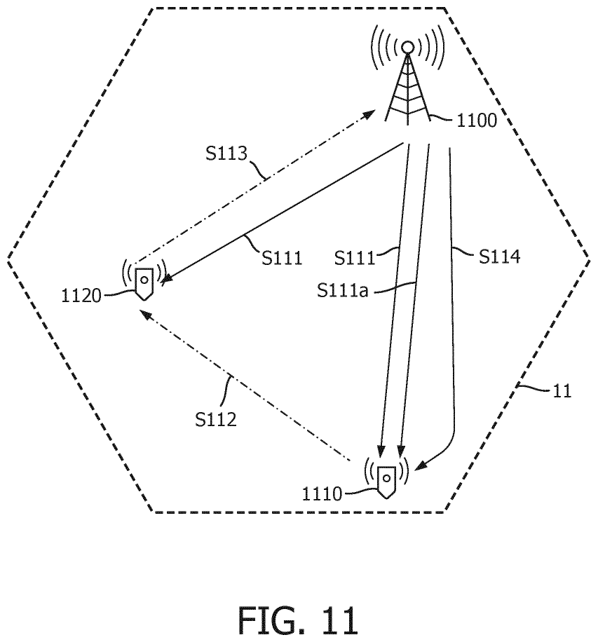

The fourth embodiment depicted on FIG. 11 corresponds to the second embodiment except that it describes the case where the wireless terminal receives downlink user data from the Core Network. As in the second embodiment, only one cell station 1100 serving cell 11 is considered.
In step S111, a cell station 1100 transmits a communication resource reservation message for example on PDCCH, that includes or indicates/encodes an identifier of the wireless terminal 1110. This resource reservation message indicates Us-resources where the wireless terminal 1110 can transmit in Sidelink (SL) and resources Us-Rx where the relay station 1120 can receive in SL. The cell station 1100 also may transmit a resource reservation indicating Ds-resources where the wireless terminal should receive downlink data. It is to be noted that the Ds-resource allocation and the Us-resource allocation may be combined in a single message, or in separate messages.
in step S111a, the cell station 1100 transmits the downlink data in the specified Ds-resources and the wireless terminal 1110 receives and decodes the user data in the Ds-resources. The Us-resources are scheduled some time after the Ds-resources such that the wireless terminal 1110 has the opportunity to send feedback data in the allocated Us-resources. As discussed in link with the second embodiment, the Us-resources and Us-Rx-resources may be allocated by means of the same message or different messages. As mentioned, in the third embodiment, the Us-resources and the Us-Rx-resources may be identical or substantially overlapping. In case of a single message allocating both the Us-resources and the Us-Rx-resources, the single message may be a PDCCH message with its CRC scrambled with an identifier selected as discussed in connection with the second embodiment, with a newly defined “Remote-UE-RNTI”.
In step S112, the wireless terminal 1110 transmits over Sidelink (SL) feedback data e.g. an acknowledgement (ACK) message or a negative acknowledgement (NACK) message to the relay station 1120, indicating respectively whether the DL data from the cell station 1100 was received correctly (ACK) or incorrectly (NACK) or possibly partly incorrectly (e.g. NACK′). Typically, the cell station 1100 may not be able to receive the transmitted data correctly due to the transmission limitations on the wireless terminal 1110 as indicated earlier. The relay station 1120 receives the feedback data transmission from the wireless terminal 1110 in the Us-Rx-resources. It is to be noted that the feedback data may be also interleaved with regular upstream data or MAC control elements such as BSRs as in the two prior embodiments on upstream user data.
In step S113, the relay station 1120 forwards the information to the cell station 1100, directly or indirectly (via e.g. further Relay UEs).
In case the feedback data indicates NACK, or alternatively feedback data was not received in time, the cell station 1100 in step S114 optionally fully or partly (in case of NACK′) retransmits relevant DL data block(s) in a new resource DL′ allocation that is sent to the wireless terminal 1110.

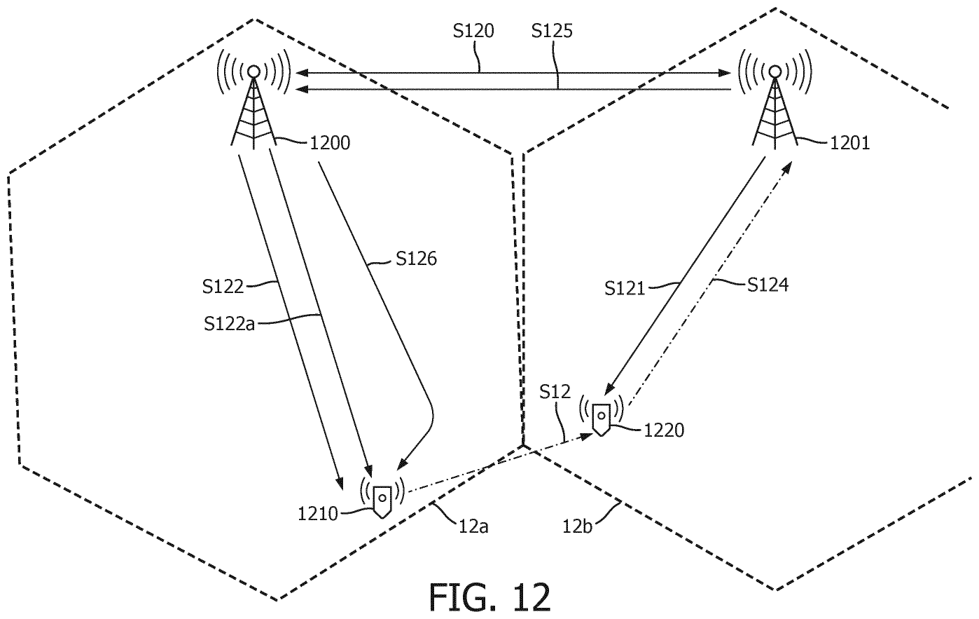

The fifth embodiment of the invention depicted on FIG. 12 corresponds to the fourth embodiment except that the relay station 1220 is now served by a cell station 1201 in cell 12b different from the cell station 1200 (in cell 12a) serving the wireless terminal 1210. Thus, this describes the case where the wireless terminal 1210 receives downlink user data from the Core Network with two cell stations playing a role.
In step S120, the cell station 1201 coordinates with the other cell station 1200 about the downlink user data for the wireless terminal 1210 and about the resource reservation of the next step as in the third embodiment. Thus, the coordination assures that Us-resources and Us-Rx-resources are equal, or at least substantially overlapping.
In step S121 the cell station 1201 transmits a communication resource reservation message, indicating Us-Rx resources where the relay station needs to receive in Sidelink (SL) for one of its Remote UE(s), the wireless terminal 1210. Details of this transmission are similar to the third and fourth embodiments for example. The relay station 1220 schedules reception on Us-Rx-resources. Optionally, as described in link with previous embodiments, step S121 may be performed earlier, for example before step S120. That is, the cell station 1201 may have selected a resource pool for the relay station 1220 to monitor on Sidelink. The cell station 1201 can thus signal that to the other cell station 1200 in step S120 as part of the coordination. Then, the cell station 1200 can then select an available resource within this resource pool.

It is to be noted that besides a resource pool, a periodic resource reservation for the relay station 1220 to listen on. This periodic resource reservation may be first configured in the relay station 1220 in a step S121. Then, after this, the two cell stations 1200 and 1201 coordinate in step S120 which resource of the periodic reservation is still available for use. The cell station 1201 can for example send one or more resource proposals to the other cell station 1200. The cell station 1201 can store this information for example in a table that lists which of the resource occasions are still free. Then in step S122, the cell station 1200 can transmit one specific resource reservation to the wireless terminal 1210.

The variant using a resource pool could work similar to the above periodic resource reservation. The cell station 1201 may keep a table of all resources in the pool and which ones are being used already. Hence, the coordination step S120 involves the cell station 1201 picking a free resource from the table and sending this information to the other cell station 1200.

Alternatively, the coordination may involve simply the cell station 1201 telling to the other cell station 1200 “pick any resource from this pool X that you like” and thus the responsibility of picking the resource(s) is delegated to the cell station 1200. If the cell station 1200 is the exclusive user of the resource pool, no collision can be expected. However, it is prone to resource collision and/or interference if multiple cell stations are all using the same resource pool and independently pick resources from it without coordination. To prevent this, the cell station 1200 can for example collect measurements itself and from many UEs about usage of resources/interference levels, in order to pick the resources right.
In step S122, the other cell station 1200 transmits a similar message, indicating Us-resources to the wireless terminal 1210. Cell station 1200 also transmits a resource reservation to the wireless terminal indicating Ds-resources for receiving downlink (DL) data. This may be in the same, or in a different message.
In step S122a, the cell station 1200 then transmits user data in the specified Ds-resources, that the wireless terminal receives and decodes. It is to be noted that the Us-resource allocation may be signaled before, after, or during transmission of the DL user data.

Besides, steps S121 and S122 may occur in parallel.
In step S123, the wireless terminal 1210 transmits feedback data e.g. an acknowledgement (ACK) message or a negative acknowledgement (NACK) message to the relay station 1220, using the Us-resources, indicating respectively whether the data from the cell station 1200 was received correctly (ACK) or incorrectly (NACK) or partly incorrectly (NACK′). This feedback is received by the Relay station 1220.
In step S124, the relay station 1220 forwards the feedback information to the cell station 1201, directly or indirectly (via e.g. Relay UEs—not shown in figure).
Optionally, in step S125 the cell station 1201 forwards all or part of feedback data to the other cell station 1200.
In case the feedback data indicates NACK/NACK′, or alternatively if no feedback data is received in time, cell station 1200 is set up to retransmit the missing/corrupted data to the wireless terminal 1210 in the next step S126 in a new resource reservation DL′.

In a particular variant of the previous embodiments, applicable to both single-gNB or dual-gNB cases, the Relay station if in range of the cell station that transmits user data directly to the wireless terminal can send back a PHY level ACK/NACK such as HARQ feedback data to the transmitting cell station—on behalf of the wireless terminal. This variant is based on the assumption that the relay station and the wireless terminal are relatively close e.g. in the same area and approximately under same radio conditions so that the feedback of the relay station has some value to indicate how well the wireless terminal received the data transmission from the transmitting cell station. The benefit here is that the transmitting cell station can directly receive feedback at PHY-level whether the data was correctly received, without waiting for an above-PHY-layer feedback information (such as PDCP feedback, or feedback information over the IP layer) that will possibly take longer to arrive and to be generated, incurring latency of DL data.

The relay station may transmit PHY feedback (e.g. HARQ feedback information) autonomously or after receiving a signal from the wireless terminal indicating its own PHY feedback. Preferably, the HARQ feedback is sent to the transmitting cell station within the HARQ feedback time interval (which is flexible in 5G, but typically may be 4 ms as in LTE). To achieve this, the relay station may receive (either from the cell station or from the wireless terminal) the RNTI value or other identity information that the cell station uses to send resource reservation messages or downlink messages to the wireless terminal. This allows the relay station to decode the PDCCH resource reservation messages and observe when a transmission to the wireless terminal takes place, after which the relay station can decide to send back a PHY level ACK/NACK such as HARQ feedback to the cell station on behalf of the wireless terminal. The relay station may in addition receive information from the cell station, or from the wireless terminal, that this latter is TX-limited and/or use recently received measurement data from the wireless terminal to determine the quality of the connection between the wireless terminal and its cell station. This can serve as a trigger for the relay station to determine when to send ACK/NACK feedback on behalf of the wireless terminal and when not to send this. Alternatively, the relay station may also observe HARQ feedback being sent between the wireless terminal and the cell station, and replicate it, if the relay station knows about the TX limited situation of the wireless terminal (and hence knows that the HARQ feedback will unlikely arrive at the cell station). To this end, the relay station may receive HARQ process information from the wireless terminal or from the cell station to act on behalf of the wireless terminal, in order to make sure the same HARQ process number and same subframes are used. In yet another alternative, the wireless terminal may send a signal to the relay station (e.g. using Sidelink) before the HARQ feedback time interval occurs with information indicating the HARQ feedback information which the relay station can then transmit to the cell station during the scheduled feedback time interval.

This means for the wireless terminal that, upon reception of the PDCCH indicative of the upcoming DL transmission, it forwards part or all of the received DCI to the relay station, such as the HARQ process number, the subframe number, to enable the relay station to provide feedback on behalf of the wireless terminal.

Similarly, in another variant of the previously discussed embodiments, if the wireless terminal transmits user data directly to the cell station (e.g. using uplink resources U that are allocated for the wireless terminal but that can also be decoded by the Relay station), the relay station can send a PHY level ACK/NACK such as HARQ feedback to the wireless terminal on behalf of the cell station. To this end, the wireless terminal may receive HARQ process information (e.g. HARQ process ID, timing/resource information) from the cell station to act on behalf of the cell station, in order to make sure the same HARQ process number and same subframes are used. The first or second cell station may also provide (e.g. through an RRC message) some security credentials or information about the type, format, encoding, scrambling or content of the signals or messages to enable the relay station to verify the integrity of the message or (partially) decode the message/signal, and may also provide instructions/policy information under which conditions (e.g. if the CRC or Message Integrity Code/Message Authentication Code is verified to be correct) the relay station would be allowed to send acknowledgement data to the wireless terminal. Note that such policy information may also be configured on the devices by the core network (e.g. through the Policy Control Function (PCF)). The relay station may use the information received from the first or second cell station to perform some processing on received uplink/upstream signals/messages from the wireless terminal, and may send acknowledgement data to the wireless terminal if the outcome of that processing meets one or more conditions. Alternatively, the relay station first forwards the received uplink/upstream signal/message to the second cell station to which it is connected (which may forward it further to the first cell station), after which the second cell station (or the first cell station indirectly through the second cell station) may send a signal/message to relay station upon successful reception/decoding/integrity verification of the forwarded uplink/upstream signal/message (instead of sending acknowledgement data directly to wireless terminal), whereby the relay station may subsequently send acknowledgement data to the wireless terminal.

The guiding assumption for the above mentioned solutions for sending acknowledgements is the (typical) case that the Relay station and Remote UEs are relatively close together and the Relay station has a higher incoming signal quality of the wireless terminal's signal, while the cell receives only a very weak signal from the wireless terminal directly. This has the benefit that, in typical cases where the cell station can receive the uplink transmission from the wireless terminal directly, the cell station can directly answer feedback information itself but in occasional situations where the cell station cannot receive the uplink transmission due to Tx-limitations, the relay station can receive the uplink data on behalf of the cell station. And then also, the relay station can respond on behalf of the cell station with feedback (e.g. ACK/NACK, or HARQ) information. The Relay station will further take care that the uplink data is relayed further to its cell station so that the data is not lost.

To perform its task, various techniques can be used by the relay station to avoid clashes with potential feedback information sent by the cell station:
the relay station may e.g. detect that the wireless terminal made a direct uplink transmission but that the cell station did not respond with PHY feedback information within an expected time frame. Then, the relay station sends this information to the wireless terminal on behalf of the cell station.
The relay station may receive instruction from the cell station to start sending feedback information on behalf of the wireless terminal. This instruction may be triggered e.g. by measurements in the cell station indicating that the wireless terminal signal is becoming very weak.
The relay station may use a random back-off time period for sending the feedback data, and the cell station may do the same. Then, the feedback responses from the relay station and the cell station will be separated in time with a certain probability; and if one party observes the other party already responded then it will not have to respond anymore.

This solution overall has the benefit that the wireless terminal (being a low-power IoT device for example with resource constraints) does not need to retransmit the uplink data that the cell station missed to the cell station or to the relay station. Reducing the need for retransmission saves energy.

In an alternative embodiment, a plurality of cell stations in the area sends a DL transmission to the wireless terminal. This provides duplication of the data sent, thus increasing the transmission robustness, and also creating diversity in radio conditions. Hence, this increases the probability of correct reception of the data by the wireless terminal. Since the Tx-limited wireless terminal is unable to send back PHY level ACK/NACK directly to one or more of the cell stations, this duplication reduces the probability of incomplete DL data transmission at the wireless terminal. Additionally, the multiple cell stations could also send resource reservation messages to the wireless terminal indicating resources Us′/Us″, each with a specific spectrum allocation that the wireless terminal could choose from and use to send upstream data if it needs to, and could send corresponding resource reservation to nearby relay stations for receiving upstream data from the wireless terminal.

In an alternative embodiment, the cell station that can reach the wireless terminal sends relay selection or relay reselection information to the wireless terminal. This information could be encoded in a System Information Block (SIB) or an RRC message or Downlink Control Information (DCI), or other type of message, and may e.g. include an L2 identity and other information of a nearby relay station (e.g. information about timing/frequency/resource on when the nearby relay station will transmit a discovery message (e.g. a ProSe/sidelink discovery message) or when the nearby relay station will listen for incoming discovery or ‘relay join request’ messages). The wireless terminal can use this information to select or reselect an optimal Relay station to use. It could also select multiple Relay stations as Parent, e.g. if suggested by the cell station information.

Such relay selection is particularly useful if the cell station was previously in contact (bi-directional) with the wireless terminal, but has just detected that a Tx-limited situation applies, that is, the signals of the wireless terminal have become too weak to be received anymore. This could be due to the wireless terminal lowering its transmission power due to energy shortage or to improve battery life, or because more power is required for another task and the total power budget is limited, or due to the wireless terminal getting out of range by movement. The cell station can then send relay selection information unidirectionally to the wireless terminal, to help it acquire a relay station quickly.

Relay reselection is used when the wireless terminal is already using a relay but should pick a better relay parent.

Additionally, the cell station can schedule resources for the relay station to be listening for a potential discovery message or ‘relay join request’ or other upstream message (e.g. PC5 signalling message) from the wireless terminal; the message indicating the wireless terminal is looking for a relay. To this end, the cell station may additionally provide information to the relay station about an identity (e.g. L2 identity) that the wireless terminal will use in its discovery message or ‘relay join request’ or upstream message. These scheduled resources may be chosen in the same range/pool as the resources communicated to the wireless terminal via the above mentioned SIB/RRC. This allows the relay station to pick up the ‘relay join request’, the discovery message and/or the upstream messages of the wireless terminal more easily and reliably. For example, it may be that the relay station had its relay function temporarily disabled in order to save energy and after reception of a message indicating the scheduled resources it decides to enable its relay function again to be able to receive the potential relay discovery request from the wireless terminal and thereafter to potentially serve as a relay for this terminal.

Optionally, the cell station may send a message to the relay station that requests it to send out SL discovery messages. These messages have the purpose to be detected by the wireless terminals, and then can be used during a relay selection process to pick the best (e.g. in terms of signal quality) relay station. The message sent by the cell station may act as a trigger for the relay station to enable its relay function, in case it was (temporarily) disabled at the time of receiving the message.

Moreover, to trigger the sending of relay (re)selection information by the cell station, it optionally may require a one-time high-power “hello” message transmission from the wireless terminal to the cell station, to notify the cell station that the wireless terminal is there and it needs a relay to transmit back (with a sustainable, lower power level). Once the cell station knows the wireless terminal is there somewhere, it can broadcast relay selection information that may be received by the wireless terminal. After relay selection/attachment the asymmetric operation per the embodiments of the invention can start. This embodiment can only work if the wireless terminal has sufficient Tx power headroom and enough energy remaining still to send the “hello” message transmission.

In an alternative embodiment, a wireless terminal on purpose switches to Tx-limited mode to conserve energy and/or to prepare for an imminent situation of getting out of Tx-coverage to its cell station. The cell station may in this case transmit already relay selection information to the wireless terminal (e.g. before the wireless terminal switches to Tx-limited mode), as detailed in the previous embodiment, after which the wireless terminal can select and setup a relay connection. Once the relay connection is active it reduces its Tx power and only transmits to its relay, not anymore to the cell station directly.
The wireless terminal may decide this autonomously and signal the cell station that it will perform this procedure.
Or, the cell station may signal to the wireless terminal that it needs to perform this procedure (relay selection information can already be included in this case). This is useful if the cell station, using its advanced RAN measurements and analytics, determines that the wireless terminal is running the risk of getting out of coverage and there are no suitable other cell stations to hand over to. To this end the cell station may transmit relay selection information or a specific signal to switch to Tx-limited mode whereby the specific signal may include an identity of the wireless terminal or a group of wireless terminals to which the wireless terminal belongs. The wireless terminal may switch to Tx-limited mode upon receiving relay selection information from the cell station, or upon receiving a specific signal from the cell station to switch to Tx-limited mode, for example if an identity of the wireless terminal matches an identity of the wireless terminal or a group of wireless terminals which the wireless terminal belongs to.

It is relevant to note that the various embodiments of the invention can be combined with LTE/NR Dual Connectivity (DC) which means being connected to multiple gNBs/cells at the same time. In both the 4G and 5G standards the “Dual Connectivity” (DC) concept is defined. This is a solution that lets a wireless terminal such as a UE connect to two cell stations (here gNBs) at the same time. Simply explained, one of the cell stations is the “master” and the other is “secondary”. In the specifications it is referred to as Master Cell Group (MCG) and Secondary Cell Group (SCG) because the single cell station could in fact be a group of cell stations due to the Carrier Aggregation (CA) feature.

This solution has a number of different variants that are specified for different use cases. For example:
LTE-NR Dual Connectivity—enables a UE to for example be connected to a master LTE eNB, while using an additional NR gNB as secondary cell to get extra throughput for downlink.
NR-NR Dual Connectivity (NR-DC)—enables a UE to for example be connected to two NR gNBs, using the master gNB for Control Plane traffic and UL on low frequencies while using the secondary gNB for User Plane DL traffic e.g. on high frequencies such as mmWave. This boosts DL data rate while providing a stable connection to CN and low-power Tx operation with long range, for the UL of the UE.

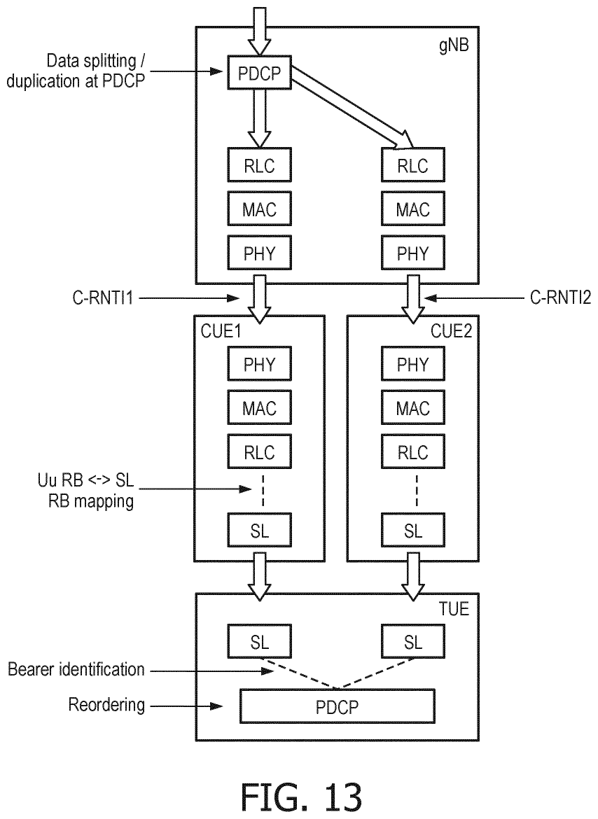

As can be seen on FIG. 13, CUE1 and CUE2 are Relay UEs and TUE is the wireless terminal acting as a Remote UE. In this case, the downlink data (resource reservation requests, user data, or feedback data) sent by the cell station to the wireless terminal may be sent by multiple gNBs.

In one refinement of the various embodiments, the cell station could employ near-realtime beam steering (e.g. directed towards the wireless terminal) where feedback is sent by the wireless terminal in form of statistics/measurements reporting via the indirect (relayed) path back to the cell stations. The feedback is used by the cell station to adapt the beam steering in closed loop. This is expected to be useful only in case the wireless terminal is static/immobile or moves very slowly, because feedback information sent via the relay path will be slower than sending feedback information directly.

In another embodiment, a low power wireless terminal, like an NB-IoT or a Machine to Machine module (e.g. LTE-M or a UE cat. 0) receives a (unidirectional) message directly from a cell station containing configuration information that invites the low-power wireless terminal to connect via a relay instead of the cell station. This is useful in case the low power wireless terminal has recently lost its connection to its cell station, at least ‘lost’ in the uplink direction. Assuming that the downlink connection is still operational (low power wireless terminal can receive), it can still receive this configuration message.

The message could also contain information about changing the CE-mode/amount of repetitions of the wireless terminal. The message could also contain a security key (e.g. stored within an encrypted container message) to let it directly connect to a relay station in its neighbourhood in a secure way.

After the low-power wireless terminal selects the relay from the configuration information, any one of the embodiments described previously may be used for further communication i.e. upstream via a relay station and for downlink directly from a cell station.

In an example of the previously discussed embodiments, the wireless terminal can use the concept of RF backscatter communication, also known as ambient backscatter (sometimes also combined with an energy harvester device). Such a backscatter communication method is useful for a very low-power device, typically but not necessarily operating without any internal energy source during the period of using backscatter communication. There are multiple cases (=device classes) possible, all within the scope of this embodiment:
1. Device has an internal energy source that it can use for regular 3GPP communications, but is able to switch to backscatter communication when desired for a period of time in order to limit the energy consumption from its internal energy source to a very low level, or not use any energy from its internal source at all by using some form of energy harvesting, e.g. RF energy harvesting or vibration energy harvesting.
2. Device has no internal energy source and the only energy source available is energy harvesting through e.g. RF waves.
3. Device has no internal energy source but has, besides energy harvesting e.g. from RF waves or vibration energy, also other external energy source(s) that may be intermittent such as solar energy, or wind energy. During times that the external energy source(s) mentioned do not provide enough energy, it can fall back to energy harvesting e.g. from RF waves or vibration energy.

The cell station can provide a powerful RF signal directly to the wireless terminal which may deliver data to the wireless terminal and which may provide energy for the RF harvester of the wireless terminal. The cell station determines at some point that the wireless terminal is Tx-limited and capable of using backscatter communication (e.g. using one of the earlier indicated methods such as capability information or state information received from the wireless terminal, or identity information (e.g. a device belonging to certain group of TX limited devices and/or backscatter devices), or information received from UDM or via NEF, etc.), and therefore it may indicate to the relay station and/or the wireless terminal to initiate or to switch to backscatter communication by e.g. one or more of:
1. providing an extended configuration for discovery message monitoring in RRC signalling (e.g. SIB19 extension or dedicated).
2. Sending a regular configuration message to the wireless terminal while it is still directly connected to the cell station or indirectly as a Remote UE without using backscatter communication; using e.g. RRC for the configuration message. It is to be noted that this may only work if the wireless terminal is capable of being in non-backscatter mode of communication.
3. Sending a configuration message to the relay station to instruct it to start listening to backscatter communications from the wireless terminal and possibly to instruct the relay station to transmit enough RF energy for harvesting by the RF energy harvester in the wireless terminal.
4. Sending/broadcasting a signal (e.g. SIB or wake-up signal) to the wireless terminal containing an indication to use backscatter communication mode (e.g. by setting a backscatter communication mode bit) and/or an identity of the wireless terminal (e.g. L2 identity, SUCI/SUPI/GUTI, or RNTI) or an identity of a group (e.g. L2 groups identity) of devices that the wireless terminal belongs to.
5. Sending/broadcasting configuration information (e.g. as part of a SIB) to the wireless terminal containing the conditions/policies that the wireless terminal should apply to decide to use backscatter communication (e.g. an RSRP threshold or a maximum number of failed uplink transmissions).

The above mentioned messages may need to be encrypted (e.g. using a pre-shared key or public key received from the first cell station (that may be signed by the core network or certificate authority or using an earlier used key or a key derived thereof (e.g. based on Kamf or Kausf or ProSe Remote User Key (PRUK)))) to prevent that a malicious device can use such messages to force the wireless terminal to switch to backscatter communication. The above mentioned messages may also contain additional information on which (type of) signals the cell station may use to enable backscatter communication by the wireless terminal and/or how the backscatter signals are to be transmitted by the wireless terminal (e.g. information how to adapt/process received signals from the cell station into backscatter signals, for example which modulation or signal encoding or scrambling or transmit power to use, which signal processing algorithm to apply (e.g. which may be indicated by an algorithm identifier), which time delay to apply, which frequency modification to apply, which multiplexing method to apply, which specific types of signals/messages will be used by the cell station or which specific types of upstream signals/messages the wireless terminal is expected to transmit (such as sidelink discovery messages) to use), which L1/L2 source or target identity information (or other identity information such as User Info ID, PRUK ID, SUCI, SUPI, GUTI, or RNTI) to use in the upstream signal/messages (e.g. the identity of the relay station), or which specific security credentials to be used for the messages.

The wireless terminal may use one or more of the above messages to decide to use backscatter communication and configure its receiver and transmitter and signal processing accordingly (e.g. in order to receive an incoming DL signal from the cell station, process the signal in such manner that it can construct an upstream signal that may include (e.g. through multiplexing, signal manipulation) the data/control information that the wireless terminal wants to transmit upstream to the cell station via a relay station. Since the backscatter signal is not reflected directly towards the cell station, the wireless terminal may deploy two sets of antennas (e.g. one to receive the DL signals from the cell station coming from one direction and one to transmit upstream signals to a relay station into another direction) or a single set of antennas that may switch intermittently between a mode for receiving DL signals from the cell station and a mode for transmitting upstream signals to a relay station. To this end, the wireless terminal may be configured by the cell station with (estimated) location information (e.g. geographical coordinates or relative coordinates or distances/directions from a reference point) of the cell station, wireless terminal and/or relay station, and/or direction information (e.g. angle between incoming DL signal from the cell station and outgoing upstream signal to the relay station, angle of departure relative to a reference line or the magnetic north of the DL signal or the upstream signal). This allows the wireless terminal to configure the antennas accordingly and receive/send the signals from/to the correct direction (e.g. by changing the beamforming characteristics of the transmitted signals). The wireless terminal may also be configured by the cell station with information about the timing of the mode switching (e.g. based on regular intervals, or in relation to the scheduled resources for downlink and upstream communication). This is useful in case of switching the antennas between a mode for receiving DL signals from the cell station and a mode for transmitting upstream signals to a relay station. Alternatively, the wireless terminal may deploy one or more omnidirectional antennas, in which case the location/angle may not be necessary and may be ignored. However, in case of a single omnidirectional antenna mode switching may be applied and the wireless terminal may be configured accordingly with information about the timing of the mode switching.

The cell station may allocate identifiers in the security context of its PLMN to identify the wireless terminals and relay stations in the vicinity that can support backscatter communication.

The cell station can choose a backscatter communication capable relay station by, e.g.
Proximity discovery data received by the cell station from a wireless terminal directly (in case this wireless terminal is not yet Tx-limited but needs to switch to Tx-limited mode soon), or from the wireless terminal via a relay station (in case the wireless terminal is already acting as a Remote UE of the relay station before switching to backscatter communication), or from the relay station directly (e.g. reporting it detects a wireless terminal in vicinity that is capable of using backscatter communication), or from other cell stations.
Historical discovery data showing the wireless terminal and its prioritized list of past relay stations.
User selected relay station.
Detection of dedicated backscatter communication-capable relay stations (symbiotic nodes) present in the vicinity of the wireless terminal, which can be selected by the wireless terminal as a relay station to use.
Based on capability information from connected relay stations or UEs capable of becoming a relay station or, capability information provided through an application function, NEF or information from UDM.

The cell station may configure the relay station in the vicinity of the wireless terminal by transmitting backscatter communication control information (BCI) e.g. in SIB18 or otherwise to define PHY/MAC properties for:
System information corresponding to backscatter communication (e.g. modulation format used, coding schemes, frequencies, schedule, etc.)
Backscatter communication channel allocation and its corresponding SL-channel mapping,
Multiple-UE backscatter communication connectivity, in which the backscattered signal from the wireless terminal can be received by multiple relay stations in the vicinity, which can then be forwarded to and aggregated at the cell station.
Congestion mitigation techniques that are configured, to prevent multiple wireless terminals to send backscatter signals at the same time such that interference can be avoided.

In backscatter communication mode, the energy required for the wireless terminal to reflect or modulate the signal towards the relay station is typically harvested from the RF signal of the cell station. The information of available harvested power in the wireless terminal (Remote UE) or received signal strength/bandwidth/frequency/density may be used for choosing device specific scheduling, modulation format, transmit power, coding schemes, protection mechanisms and connection termination indication. For example,
the wireless terminal while already operating on the RF-harvested energy may autonomously decide on such a set of parameters based on available energy.
the wireless terminal, while still in non-backscatter communication mode, may measure incoming RF power and/or other signal characteristics and report this to the cell station (directly or indirectly via its relay station) first and then the cell station may propose the parameters to use and communicate this to the wireless terminal. Then when the wireless terminal starts using RF-backscatter communication mode it will use the specified parameters for transmission.
the cell station may provide configuration information (e.g. through SIB or RRC) about the set of parameters to use for different levels of available RF-harvested energy and/or different RF signal strengths/bandwidths/frequencies/densities and/or different RF signal types to the wireless terminal, which may use this configuration information to select the set of parameters to use for the upstream signal towards the relay station. These parameters may be different per cell or Synchronization Signal Block (SSB).

Upon successful completion of backscatter communication during a period of time, the devices involved may be returned to normal state. For example,
Return to Tx-limited operation without backscatter communication as specified in this invention.
Return to operation as a wireless terminal directly connected to the cell station, without using a relay station.
Using both a direct cell station connection plus one or more relayed connections, or only one or more relay connections, etc.

When the wireless terminal stops using RF backscatter communication, a relay station may optionally continue to listen for backscatter signals/requests from pre-authorized wireless terminal(s) that are present within the pre-established security context. This is e.g. useful to detect devices that can only use RF-backscatter communication at this time and that enter the vicinity of the relay station and that need to communicate. To this end, the pre-authorized wireless terminals may need to use a specific identity or credential in its discovery, ‘relay join request’ or other upstream signals/messages (e.g. PC5 signalling messages). The relay station may be configured with the corresponding information or may remember this from previous communication with the wireless terminal (e.g. uses the same or derived PC5 session key), to enable it to verify that the wireless terminal is pre-authorized. Alternatively, the relay station may forward an incoming RF backscatter communication to the cell station to which it is connected and/or to the core network for further processing and further checking whether the wireless terminal is pre-authorized.

In other words, in order to enable RF backscatter communication, a wireless terminal may be configured for communicating in a cellular network, said cellular network further comprising at least one first cell station, said first cell station serving a first cell, and at least one relay station served by a second cell station serving a second cell,
the wireless terminal comprising
a controller to operate in a backscatter communication mode and capable to configure a receiver and a transmitter,
a receiver adapted in the backscatter communication mode to receive first downlink signals sent directly by the first cell station and carrying respective first downlink control information, wherein at least one of the respective first downlink control information includes at least an indication of a first resource and/or configuration parameter (e.g. specific modulation) to be used by the wireless terminal for transmitting a second signal directly to the relay station and at least one of said respective first downlink control information includes at least a second allocated downlink resource to be used by the wireless terminal for receiving a further downlink signal directly from the first cell station,
the controller being adapted to generate uplink information,
a transmitter adapted in the backscatter communication mode to transmit to the relay station on the first resource the second signal carrying the uplink information, said uplink information to be forwarded to the second cell station, and the receiver is further adapted to receive the further downlink signal directly from the first cell station on the second allocated downlink resource. As an option, the controller may initiate backscatter communication mode operation after the receiver has received a downlink signal sent directly by the first cell station that indicates or includes a trigger to activate backscatter communication mode. As another option, the controller initiates backscatter communication mode operation if the transmit or receive operation meets one or more (pre-)configured signal strength/signal reception quality thresholds or signal transmission failure thresholds, or if the energy levels of the wireless terminal are below a certain threshold, or if a relay station is discovered. As yet another option, the transmitter is adapted to transmit an initial signal directly to the first cell station or to the relay station that indicates or includes a trigger to activate backscatter communication mode.

The controller may be further adapted to harvest energy from incoming downlink signals and/or perform signal processing on the incoming downlink signals from the first cell station, whereby the controller may process an incoming signal in such a way that it generates an output signal, which may include or into which the uplink information is multiplexed, so that the output signal (i.e. an upstream signal/message to be received by the relay station) carries the uplink information.

As a further option, the receiver and transmitter may each operate a different set of antennas, and the controller may instruct the transmitter to perform beamforming into the direction of a relay station, e.g. based on location of the relay station and/or angle information (e.g. angle between a beam used for a downlink signal from the cell station as received by the wireless terminal, and the beam used for an upstream signal directed towards a relay station). Such position information or angle information may be received from the first cell station and/or the relay station.
As yet a further option, the controller operates alternatively in accordance with the backscatter communication mode and a second operation mode and capable to configure the receiver and transmitter to operate in the selected mode, the receiver adapted in the second operation mode to receive second downlink signals sent directly by the first cell station and carrying respective second downlink control information, wherein at least one of the respective second downlink control information includes at least an indication of a third allocated uplink resource to be used by the wireless terminal for transmitting a first uplink signal directly to the first cell station and at least one of the respective second downlink control information includes at least an indication of a fourth allocated downlink resource to be used by the wireless terminal for receiving a further downlink signal directly from the first cell station, the transmitter adapted in the second operation mode to transmit to the first cell station on the third allocated uplink resource for direct communication to the first cell station, and the receiver is configured by the controller to receive the further downlink signal directly from the first cell station on the fourth allocated downlink resource, and whereby a signal transmitted uplink to the first cell station may be a reflected backscatter signal, which may be processed to carry uplink information that may be generated by the controller.

As mentioned throughout this description, the embodiments and variants of this invention are relevant in the 3GPP 5G standardization context. They can be applied in:
Medical applications/connected healthcare in which multiple wireless (4G/5G) connected sensor- or actuator nodes participate.
Medical applications/connected healthcare devices with small form factor, e.g. a HealthDot patch to be placed on skin with built-in sensing
General IoT applications involving wireless, mobile or stationary, sensor or actuator nodes.
   E.g. smart city, logistics, farming, etc.
   In general, any IoT applications where the UE needs to be low-power, cheap or small-form-factor.
Emergency services, public services & critical communication applications
V2X systems in general
V2P systems specifically, where a person (P) carries a wireless terminal that has limited battery capacity and/or limited transmit power
Improved coverage for 5G cellular networks using high-frequency (e.g. mmWave) RF communication
Any other application areas of 4G/5G communication where a relay station is used.

It is to be noted that the embodiments described above are not limited to Out-of-Coverage devices. It is also beneficial for any wireless terminals even when operating in coverage of the cell. Indeed, as explained earlier, the wireless terminals would be able to reduce the amount of power required to operate as using the indirect link enables lower energy consuming communication while at the same time using the direct link avoids the cost of monitoring/sensing of Sidelink resources for example.

Moreover, it will be understood by those skilled in the art that, in general, terms used herein, and especially in the appended claims, are generally intended as “open” terms, e.g., the term “including” should be interpreted as “including but not limited to,” the term “having” should be interpreted as “having at least,” the term “comprises” should be interpreted as “comprises but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.

The apparatus may be implemented by a program code means of a computer program and/or as dedicated hardware of the related devices, respectively. The computer program may be stored and/or distributed on a suitable medium, such as an optical storage medium or a solid-state medium, supplied together with or as part of other hardware, but may also be distributed in other forms, such as via the Internet or other wired or wireless telecommunication systems.

1. A wireless terminal for communicating in a cellular network, the cellular network comprising at least one first cell station, the first cell station serving a first cell, and at least one relay station served by a second cell station serving a second cell, the wireless terminal comprising:
a controller to operate in a TX-limited operation mode,
a receiver configured by the controller in the TX-limited operation mode to receive first downlink signals sent directly by the first cell station and carrying respective first downlink control information, wherein at least one of the respective first downlink control information includes at least an indication of a first configuration parameter to be used by the wireless terminal for transmitting a signal directly to the relay station and at least one of the respective first downlink control information includes at least a second configuration parameter to be used by the wireless terminal for receiving a further downlink signal directly from the first cell station,
the controller being adapted to generate uplink information,
a transmitter configured by the controller in the TX-limited operation mode to transmit to the relay station using the first configuration parameter the second signal carrying the uplink information, the uplink information to be forwarded to the second cell station, and
wherein the receiver is further adapted to receive the further downlink signal directly from the first cell station using the second configuration parameter.

2. The wireless terminal of claim 1, wherein the controller initiates TX-limited operation mode after the reception by the receiver of a TX limited operation mode activation signal, being a downlink signal sent directly by the first cell station indicating or triggering TX-limited operation mode activation.

3. The wireless terminal of claim 1, wherein the controller initiates TX-limited operation mode operation if the transmit or receive operation meets one or more preconfigured signal strength/signal reception quality threshold or one or more signal transmission failure threshold, or if the energy levels of the wireless terminal are below a certain threshold, or upon discovery of the relay station.

4. The wireless terminal of claim 1, wherein the transmitter is adapted to transmit an initial signal to the first cell station and/or to the relay station indicating or triggering TX-limited operation mode activation.

5. The wireless terminal of claim 1,
wherein the controller is adapted to operate alternatively in accordance with a first operation mode, wherein the first operation mode is the TX-limited operation mode, and a second operation mode,
wherein the receiver, in the second operation mode, is adapted to receive second downlink signals sent directly by the first cell station and carrying respective second downlink control information, wherein at least one of the respective second downlink control information includes at least an indication of a third configuration parameter to be used by the wireless terminal for transmitting an uplink signal directly to the first cell station and at least one of the respective second downlink control information includes at least an indication of a fourth configuration parameter to be used by the wireless terminal for receiving a further downlink signal directly from the first cell station, and the controller being adapted to generate uplink information; and
wherein the transmitter is configured by the controller in the second mode of operation to transmit to the first cell station using the third configuration parameter for direct communication to the first cell station, and the receiver is configured by the controller to receive the further downlink signal directly from the first cell station using the fourth configuration parameter.

6. The wireless terminal of claim 5, wherein the receiver is further adapted to receive a third downlink signal sent by the first cell station and carrying third downlink control information, the third downlink control information including at least an indication of an upcoming downlink resource on which user data transmitted by the first cell station is to be received, and wherein the controller is adapted to configure the receiver for receiving the user data.

7. The wireless terminal of claim 6, wherein the uplink information includes acknowledgement data based on the determination of whether the user data has been successfully decoded, the acknowledgement data being transmitted by the transmitter to the first cell station using the third configuration parameter when the controller operates in the second operation mode or to the relay station using the first configuration parameter when the controller operates in the first operation mode.

8. The wireless terminal of claim 5, wherein the uplink information includes at least one uplink user data packet, wherein the user data packet is sent directly to the first cell station in the second operation mode and wherein the user data packet is to be forwarded by the relay station to the second cell station in the first operation mode.

9. The wireless terminal of claim 8, wherein the receiver is adapted to receive further downlink control information including an indication of whether the uplink user data packet is decoded successfully.

10. The wireless terminal of claim 9, wherein the first cell station and the second cell station are a single cell station.

11. The wireless terminal of claim 1, wherein the transmitter is adapted to use backscatter communication.

12. A cellular communication system comprising:
at least one first cell station, the first cell station serving a first cell;
at least one relay station served by a second cell station serving a second cell;
a wireless terminal served by the first cell station;
wherein the first cell station comprises a first cell station transmitter for transmitting directly to the wireless terminal a first downlink signal and carrying first downlink control information, the first downlink control information including at least an indication of a first configuration parameter to be used by the wireless terminal for transmitting a signal to the relay station,
wherein the second cell station comprises a second cell station transmitter for transmitting to the relay station a second downlink signal and carrying second downlink control information, the second downlink control information including at least an indication of a second configuration parameter to be used by the relay station for receiving the signal from the wireless terminal, wherein the first and second configuration parameter at least partially overlap, the wireless terminal comprising a wireless terminal controller adapted to generate uplink information, and a wireless terminal transmitter configured by the wireless terminal controller to transmit to the relay station using the first configuration parameter a message carrying the uplink information, and
wherein the relay station compose a relay station receiver adapted to receive the message using the second configuration parameter.

13. The cellular communication system of claim 12, wherein the relay station comprises a relay station transmitter for transmitting to the second cell station a relayed message including the uplink information.

14. The cellular communication system of claim 13 wherein the second cell station is adapted to transmit to the relay station a third downlink signal carrying third downlink control information, wherein the third downlink control information includes at least an indication of a third configuration parameter that is used by the relay station for transmitting the relayed message to the second cell station.

15. The cellular communication system of claim 14, wherein the first downlink signal and the second downlink signal are a single downlink signal being received at the wireless terminal and at the relay station.

16. The cellular communication system of claim 14, wherein the second downlink signal and the third downlink signal are a single downlink signal being received at the relay station.

17. The cellular communication system of claim 1, wherein the message carrying the uplink information includes at least one uplink user data packet to be forwarded by the relay station to the second cell station.

18. A relay station operating in a cellular communication network, comprising:
at least one first cell station, the first cell station serving a first cell and a wireless terminal served by the first cell station,
wherein the relay station is served by a second cell station serving a second cell,
wherein the relay station comprises
a relay station receiver adapted to receive from the second cell station a second downlink signal carrying second downlink control information, and
wherein the second downlink control information including at least an indication of at least one first configuration parameter for receiving a message from the wireless terminal;
a relay station controller for controlling the relay station receiver to receive the message including uplink information on the first configuration parameter;
and
a relay station transmitter adapted for forwarding the uplink information in a relayed-data message to the second cell station.

19. A first cell station serving a first cell in a cellular communication system, comprising:
at least one relay station served by a second cell station serving a second cell,
a wireless terminal served by the first cell station, wherein the first station cell station comprises:
a first cell station transmitter for transmitting to the wireless terminal a first downlink signal carrying first downlink control information, the first downlink control information including at least an indication of a first configuration parameter to be used by the wireless terminal for transmitting a message to the relay station,
a first cell station controller for configuring the relay station with second downlink control information, the second downlink control information including at least an indication of a second configuration parameter to be used by the relay station for receiving the message from the wireless terminal, wherein the first and second resource at least partially overlap.

20. A method for operating a wireless terminal to communicate in a cellular network, the cellular network comprising at least one first cell station, wherein the said first cell station serves a first cell, and at least one relay station served by a second cell station, wherein the second cell station serves a second cell, comprising:
the wireless terminal receiving a downlink signal sent by the first cell station and carrying downlink control information, wherein the downlink control information including at least an indication of a first configuration parameter to be used by the wireless terminal for transmitting a message to the relay station;
the wireless terminal generating uplink information; and
the wireless terminal transmitting to the relay station using the first configuration parameter the message carrying the uplink information, wherein the uplink information is to be forwarded to the second cell station.
